(19) United States
(12) Patent Application Publication
(10) Pub. No.: US 2022/0291826 A1
(43) Pub. Date: Sep. 15, 2022

(54) DISPLAY APPARATUS, DISPLAY SYSTEM, AND METHOD FOR CONVERTING

(71) Applicant: Masashi OGASAWARA, Tokyo (JP)

(72) Inventor: Masashi OGASAWARA, Tokyo (JP)

(21) Appl. No.: 17/673,790

(22) Filed: Feb. 17, 2022

(30) Foreign Application Priority Data
Mar. 12, 2021 (JP) 2021-040560

(51) Int. Cl. G06F 3/04883; G06V 30/142; G06V 30/148; G06V 10/44; G06V 10/26

(52) U.S. Cl. CPC G06F 3/04883; G06V 30/1423; G06V 30/153; G06V 10/443; G06V 10/26

(57) ABSTRACT

A display apparatus includes circuitry that displays a table on a screen. The circuitry acquires, from a memory, an attribute associated with the table; receives handwritten data input to the table by a user operation; and converts the handwritten data into a character string so as to have an appearance in accordance with the attribute associated with the table.

### CROSS-REFERENCE TO RELATED APPLICATION

This patent application is based on and claims priority pursuant to 35 U.S.C. § 119(a) to Japanese Patent Application No. 2021-040560, filed on Mar. 12, 2021, in the Japan Patent Office, the entire disclosure of which is hereby incorporated by reference herein.

### BACKGROUND

### Technical Field

Embodiments of the present disclosure relate to a display apparatus, a display system, and a method for converting a table on a display.

### Related Art

There are related art display apparatuses such as electronic whiteboards having a touch panel display that displays an object formed by strokes handwritten by a user with an input device, such as a dedicated electronic pen, or a finger. A display apparatus having a relatively large touch panel is used in a conference room or the like, and is shared by a plurality of users as an electronic whiteboard or the like.

Some display apparatuses receive input of a table handwritten by the user with the input device or a finger.

### SUMMARY

An embodiment of the present disclosure provides a display apparatus that includes circuitry to display a table on a screen. The circuitry acquires, from a memory, an attribute associated with the table; receives handwritten data input to the table by a user operation; and converts the handwritten data into a character string so as to have an appearance in accordance with the attribute associated with the table.

Another embodiment provides a display system that includes the above-described display apparatus, a server that receives, from the display apparatus, the converted character string and data of the table, and a communication terminal that communicates with the server via a network. The communication terminal displays the table and the converted character string received from the server.

Another embodiment provides a display system that includes a display apparatus including first circuitry to display a table on a screen; and a server including second circuitry. The second circuitry of the server receives, from the display apparatus, data of the table and handwritten data input to the table by a user operation; acquires, from a memory, an attribute associated with the table; converts the handwritten data into a character string so as to have appearance in accordance with the attribute associated with the table; and transmits, to the display apparatus, the converted character string and data of the table. The first circuitry of the display apparatus displays the table and the converted character string.

Another embodiment provides a method for converting a table on a display. The method includes displaying the table on the display; acquiring, from a memory, an attribute associated with the table; receiving handwritten data input to the table by a user operation; and converting the handwritten data into a character string so as to have an appearance in accordance with the attribute associated with the table.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIGS. 1A and 1B are diagrams illustrating an outline of formatting a table in accordance with an attributes of the table;

FIG. 2 is a diagram illustrating an example of a general arrangement of a communication system including one or more display apparatuses according to one embodiment;

FIG. 3 is a block diagram illustrating an example of a hardware configuration of the display apparatus according to one embodiment;

FIG. 4 is a block diagram illustrating a functional configuration of the display apparatus according to one embodiment;

FIGS. 5A to 5D are diagrams illustrating an operation detected as an event by the display apparatus according to one embodiment;

FIG. 6 is a diagram illustrating an example of a user interface (UI) of the display apparatus according to one embodiment;

FIGS. 7A and 7B illustrate an example of a handwritten table on a display by a user;

FIG. 8 is a diagram illustrating a table converted from handwritten table by formatting by a table processing unit illustrated in FIG. 4;

FIG. 9 illustrates examples of handwritten data and character strings in the table formatted in FIG. 8;

FIG. 10 illustrates an example of a table operation menu displayed on the display apparatus according to one embodiment;

FIG. 11 is an example of a flowchart illustrating a process performed by the display apparatus when a table format button illustrated in FIG. 10 is pressed;

FIG. 12 is a diagram illustrating an example of a displayed table formatted by the process illustrated in FIG. 11;

FIG. 13 is a diagram illustrating an example of setting of attributes of a table;

FIG. 14 is a first diagram illustrating details of a table setting screen illustrated in FIG. 13;

FIGS. 15A to 15E are second diagrams illustrating details of the table setting screen illustrated in FIG. 13;

FIG. 16 is a third diagram illustrating details of the table setting screen illustrated in FIG. 13;

FIGS. 17A to 17C are diagrams illustrating adjustment of cell size using an on/off slide button for “auto-adjust cell size to text”, illustrated in FIG. 13;

FIG. 18 is a fourth diagram illustrating details of the table setting screen illustrated in FIG. 13;

FIG. 19 is a fifth diagram illustrating details of the table setting screen illustrated in FIG. 13;

FIG. 20 is a diagram illustrating an example of a color palette;

FIG. 21 is a sixth diagram illustrating details of the table setting screen illustrated in FIG. 13;

FIG. 22 illustrates an example of a cell attribute setting screen according to one embodiment;

FIG. 23 is a diagram illustrating an example of a setting button pressed by a user for setting an initial value;

FIG. 24 illustrates an example of a various settings screen displayed, in response to pressing of the setting button illustrated in FIG. 23;

FIG. 25 illustrates an example of an initial value setting screen;

FIG. 26 is a schematic diagram illustrating an example of a configuration of a display system according to one embodiment;

FIG. 27 is a diagram illustrating a configuration of a display system according to another embodiment;

FIG. 28 is a diagram illustrating a configuration of a display system according to another embodiment;

FIG. 29 is a diagram illustrating a configuration of a display system according to another embodiment; and

FIG. 30 is a diagram illustrating a configuration of a display system according to another embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a display apparatus and a method for converting a table performed by the display apparatus according to embodiments of the present disclosure, with reference to the attached drawings.

### Embodiment 1

Outline of Converting Handwriting in Table According to Table Attribute

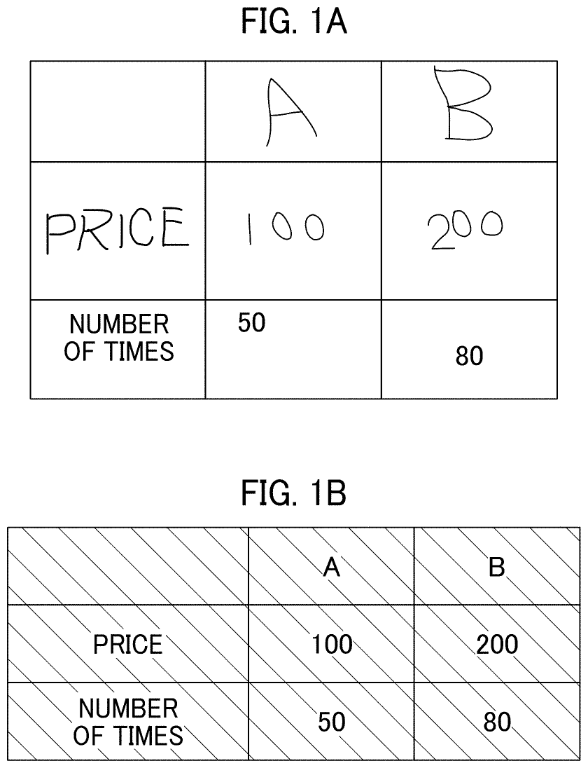

FIGS. 1A and 1B are diagrams illustrating an outline of formatting a table in accordance with an attributes of the table. FIG. 1A illustrates a table generated on a display by a user. In the table, character strings (fonts) and handwriting are mixed.

The inventor recognizes that it is difficult to convert handwriting in a table in accordance with an attribute set to the table in a conventional technology. For example, when a plurality of users inputs handwriting on one table, the table includes handwritten objects different in size, color, and the like. In this case, when the display apparatus simply converts the handwritten objects into character strings, the converted character strings may be different in character size, color, or the like. As a result, the table has a poor visibility, which may discourage the discussion.

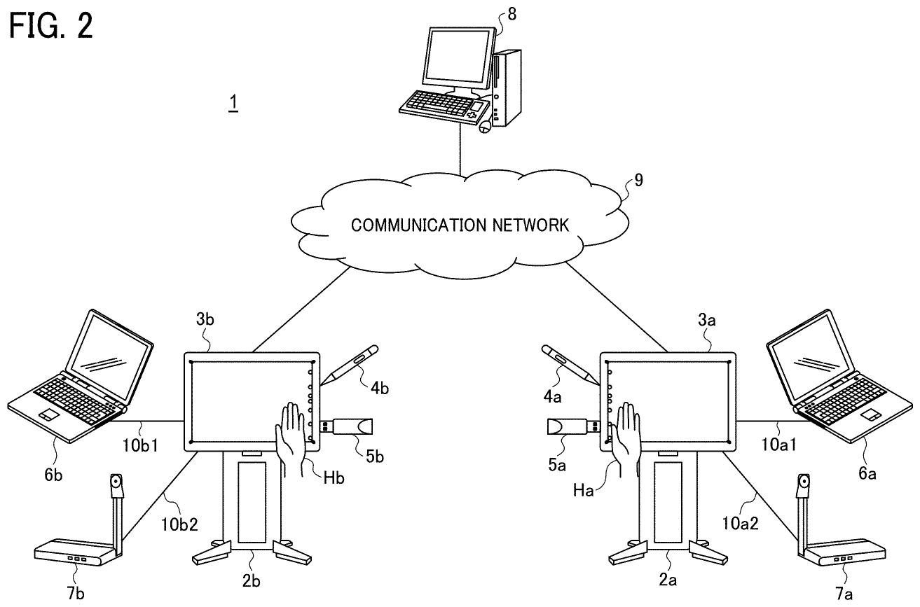

In view of the above, a display apparatus according to an embodiment of the present disclosure converts a handwritten data in a table so as to have appearance in accordance with an attribute set to the table. In this disclosure, processing to change appearance of the character string, converted from the handwritten data, is referred to as “formatting”. In the present embodiment, the user instructs the display apparatus 2 to format handwritten objects in the table by operating, e.g., a menu, or a display apparatus 2 (2a or 2b illustrated in FIG. 2) automatically performs formatting.

The display apparatus 2 performs character recognition on handwritten data, to convert the handwritten data into a character string. Then, the display apparatus 2 displays the character string formatted in accordance with the attributes (font, size, arrangement, color, etc.) set to the table. When the table already includes a character string, the display apparatus 2 displays the character string formatted in accordance with the attribute.

FIG. 1B illustrates an example of a table formatted in accordance with the table attribute. In FIG. 1B, the character size in each cell is adjusted in accordance with the table attribute, and cells are displayed in the same color after the formatting.

As described above, the display apparatus 2 according to the present embodiment formats a table in accordance with the attribute. Accordingly, the display apparatus 2 displays a table with a sense of unity even when the plurality of users inputs handwriting in different styles. Then, the table has an improved visibility, thereby fostering discussion or the like using the table.

### Terms

“Input device” may be any means capable of handwriting by designating coordinates on a touch panel. Examples thereof include an electronic pen, a human finger or hand, and a bar-shaped member.

A series of user operations including engaging a writing mode, recording movement of an input device or portion of a user, and then disengaging the writing mode is referred to as a stroke. The engaging of the writing mode may include, if desired, pressing an input device against a display or screen, and disengaging the writing mode may include releasing the input device from the display or screen. Alternatively, a stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The disengaging of the writing mode can be accomplished by the same or different gesture used to engage the writing mode, releasing the button, or otherwise turning off the writing mode, for example using the pointing device or mouse.

“Stroke data” is data based on a trajectory of coordinates of a stroke input with the input device, and the coordinates may be interpolated appropriately. “Handwritten data” is data having one or more stroke data. “Handwriting input” represents input of handwritten data by a user.

An “object” refers to an item displayed on a screen. The term “object” in this specification represents an object of display. Examples of “object” include objects displayed based on stroke data, objects obtained by handwriting recognition from stroke data, graphics, images, characters, and the like.

A character string converted by character recognition from the handwritten data may include, in addition to text data, data displayed based on a user operation, such as a stamp of a given character or mark such as “complete,” a graphic such as a circle or a star, or a line.

The character string includes one or more characters handled by a computer. The character string actually is one or more character codes. Characters include numbers, alphabets, symbols, and the like. The character string is also referred to as text data.

Conversion includes converting (character recognition processing) handwritten data into one or more character codes and displaying a character string represented by the character codes in a predetermined font. Conversion further includes displaying the character string, obtained through character recognition processing, so as to have appearance in accordance with an attribute. Conversion further includes converting handwritten data into a shape (graphic) such as a straight line, a curved line, or a square, or a table. In this embodiment, such conversion, which is to be performed in accordance with an attribute, is referred to as “formatting.”

An attribute determines an appearance of information displayed in the table, such as a font, a font size, an arrangement, or a color of a character in the table, and an appearance of the table itself, such as a color or a thickness of ruled lines of the table.

System Configuration

FIG. 2 is a diagram illustrating an example of a general arrangement of a communication system including one or more display apparatuses according to one embodiment. FIG. 2 illustrates one example in which a communication system 1 includes two display apparatuses 2a and 2b (also collectively referred to as “display apparatuses 2”) and two electronic pens 4a and 4b (also collectively referred to as “electronic pens 4”). However, the number of display apparatuses and the number of electronic pens may be three or more.

As illustrated in FIG. 2, the communication system 1 includes the plurality of display apparatuses 2a and 2b, the plurality of electronic pens 4a and 4b, Universal Serial Bus (USB) memories 5a and 5b, laptop computers 6a and 6b, videoconference terminal (teleconference terminal) 7a and 7b, and a personal computer (PC) 8. The display apparatuses 2a and 2b and the PC 8 are connected to each other via a communication network 9 to communicate with each other. Further, the display apparatuses 2a and 2b include displays 3a and 3b (or screens), respectively.

The display apparatus 2a displays, on the display 3a, an image drawn by an event generated by the electronic pen 4a (e.g., a touch of the tip or bottom of the electronic pen 4a on the display 3a). The display apparatus 2a may change the image being displayed on the display 3a, according to an event made by the user's hand Ha not limited to the electronic pen 4a. An example of the event is a user hand gesture indicating enlargement, reduction, or page turning.

The USB memory 5a is connectable to the display apparatus 2a. The display apparatus 2a can read electronic files in, for example, a portable document format (PDF) from the USB memory 5a or can store an electronic file in the USB memory 5a. The display apparatus 2a is connected to the laptop computer 6a via a cable 10a1 capable of communicating in compliance with a communication standard such as DISPLAYPORT, a digital visual interface (DVI), and HIGH-DEFINITION MULTIMEDIA INTERFACE (HDMI), or Video Graphics Array (VGA). On the display apparatus 2a, an event is caused by a user operation of contact with the display 3a (screen). The display apparatus 2a transmits event information indicating the event to the laptop computer 6a in a similar manner to an event caused by a user operation of inputting with an input device, such as a mouse and a keyboard. In a substantially the same manner, the videoconference terminal (teleconference terminal) 7a is connected to the display apparatus 2a via a cable 10a2 for communication in compliance with the above-described standard. Alternatively, the laptop computer 6a and the videoconference terminal 7a may communicate with the display apparatus 2a through wireless communications in compliance with various kinds of radio communication protocols such as BLUETOOTH.

At another site where the display apparatus 2b is provided, in a similar manner to the above, the display apparatus 2b including the display 3b (screen), the electronic pen 4b, the USB memory 5b, the laptop computer 6b, the videoconference terminal 7b, a cable 10b1, and a cable 10b2 are used. In addition, an image displayed on the display 3b is modifiable according to an event caused by a user operation using a hand Hb of a user, for example.

With this configuration, an image drawn on the display 3a of the display apparatus 2a at a first site is also displayed on the display 3b of the display apparatus 2b at a second site. Conversely, an image drawn on the display 3b of the display apparatus 2b at the second site is displayed on the display 3a of the display apparatus 2a at the first site. As described above, the communication system 1 operates for sharing the same image between remotely located sites. Due to this, using the communication system 1 in a videoconference conducted between remotely located sites is very convenient.

In the following, the “display apparatus 2” refers to any one of the plurality of display apparatuses 2. Similarly, the “display 3” refers to any one of the plurality of displays 3a and 3b. The “electronic pen 4” refers to any one of the plurality of electronic pens 4. The “USB memory 5” refers to any one of the plurality of USB memories 5. The “laptop computer 6” refers to any one of the plurality of laptop computers 6a and 6b. Any one (videoconference terminal) of the plurality of videoconference terminals 7 may be referred to as the “videoconference terminal” 7. Any one of the hands of users may be referred to as the “hand H.” Any one of the plurality of cables may be referred to as the “cable 10.”

In the present embodiment, the display apparatus 2 is, but not limited to, an electronic whiteboard. Other examples of the display apparatus 2 include an electronic signboard (digital signage), a telestrator that is used, for example, in sports and weather broadcasts, and a remote image (video) diagnostic apparatus. The laptop computer 6 is an example of an information processing terminal. The information processing terminal may be any terminal that supplies image frames, and examples thereof include a desktop PC, a tablet PC, a personal data assistance (PDA), a digital video camera, a digital camera, and a game console. Further, the communication network includes, for example, the Internet, a local area network (LAN), and a mobile communication network. In the present embodiment, the USB memory 5 is used as a recording medium, but the recording medium may be any desired recording medium, such as a secure digital (SD) card.

Hardware Configuration of Display Apparatus

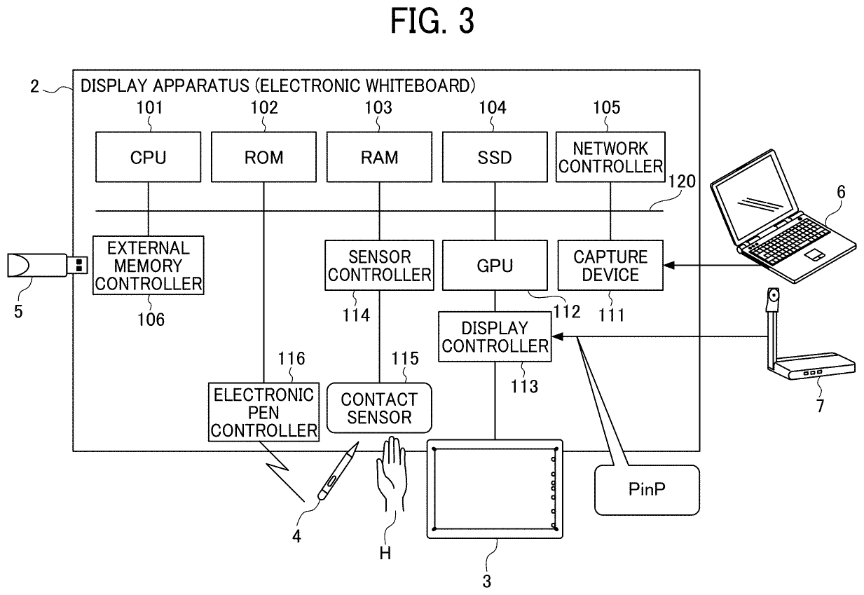

A description is given of a hardware configuration of the display apparatus 2 according to the present embodiment, with reference to FIG. 3. FIG. 3 is a diagram illustrating an example of the hardware configuration of the display apparatus 2 according to the present embodiment.

As illustrated in FIG. 3, the display apparatus 2 includes a central processing unit (CPU) 101 that controls entire operation of the display apparatus 2, a read only memory (ROM) 102 that stores a program for operating the CPU 101 such as an initial program loader (IPL), a random access memory (RAM) 103 that serves as a work area for the CPU 101, a solid state drive (SSD) 104 that stores various types of data including control program for the display apparatus 2, a network controller 105 that controls communication via the communication network 9, and an external memory controller 106 that controls communication with the USB memory 5.

The SSD 104 stores various data such as an operating system (OS) and a control program for the display apparatus 2. The program may be an application program that runs on an information processing apparatus equipped with a general-purpose operating system (OS) such as WINDOWS, MAC OS, ANDROID, and IOS. That is, the display apparatus 2 may be a general-purpose information processing apparatus.

The display apparatus 2 further includes a capture device 111 that displays video data as a still image or a moving image on a display of the laptop computer 6, a graphics processing unit (GPU) 112 that is dedicated for graphics processing, and a display controller 113 that controls and manages a screen display to output image data from the GPU 112 to the display 3 or the videoconference terminal 7, for example. When there are inputs from both the laptop computer 6 and the video conference terminal 7, the display controller 113 displays the input from the laptop computer 6 on a main screen of the display 3 and displays the input from the video conference terminal 7 on a sub screen of the display 3 as picture in picture (PinP).

The display apparatus 2 further includes a sensor controller 114 and a contact sensor 115. The sensor controller 114 controls the contact sensor 115. The contact sensor 115 detects a touch onto the display 3 with the electronic pen 4 or the user's hand H. The contact sensor 115 inputs coordinates or detects coordinates using, for example, an infrared blocking method. In this method, two light receiving and emitting device, disposed on both upper side ends of the display 3, emit infrared ray (a plurality of lines of light) in parallel to a surface of the display 3. The infrared ray is reflected by a reflector provided around the display 3, and a light-receiving element receives light returning along the same optical path as that of the emitted light. The contact sensor 115 outputs, to the sensor controller 114, a position where the light is blocked by an object. The sensor controller 114 determines, by triangulation, a coordinate position that is touched by the object.

The contact sensor 115 is not limited to a sensor using the infrared blocking method, and may be a different type of detector, such as a capacitance touch panel that identifies a contact position by detecting a change in capacitance, a resistance film touch panel that identifies a contact position by detecting a change in voltage of two opposed resistance films, or an electromagnetic induction touch panel that identifies a contact position by detecting electromagnetic induction caused by contact of an object with the display.

The display apparatus 2 further includes an electronic pen controller 116. The electronic pen controller 116 communicates with the electronic pen 4 to detect a touch by the tip or bottom of the electronic pen 4 on the display 3. In addition or in alternative to detecting a touch by the tip or bottom of the electronic pen 4, the electronic pen controller 116 may also detect a touch by another part of the electronic pen 4, such as a part held by a hand of the user.

The display apparatus 2 further includes a bus line 120 such as an address bus and a data bus to electrically connects the CPU 101, the ROM 102, the RAM 103, the SSD 104, the network controller 105, the external memory controller 106, the capture device 111, the GPU 112, the sensor controller 114, and the electronic pen controller 116 to each other, as illustrated in FIG. 3.

Functional Configuration of Display Apparatus

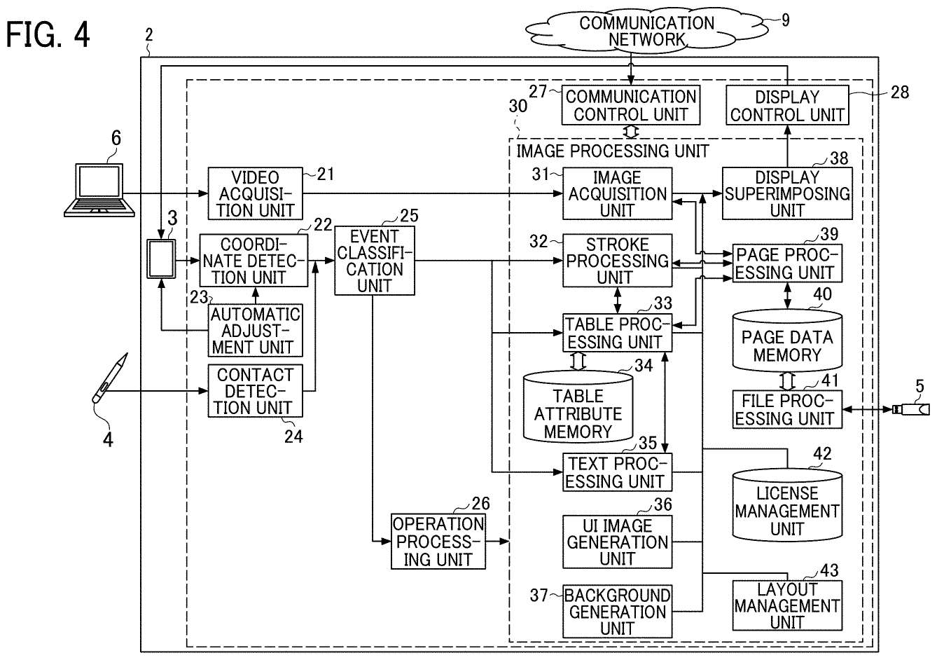

A functional configuration of the display apparatus 2 is described with reference to FIG. 4. FIG. 4 is a block diagram illustrating a functional configuration of the display apparatus 2.

The functional configuration of the display apparatus 2 illustrated in FIG. 4 is implemented by the hardware configuration of FIG. 3 that operates according to a program. The display apparatus 2 includes a video acquisition unit 21, a coordinate detection unit 22, an automatic adjustment unit 23, a contact detection unit 24, an event classification unit 25, an operation processing unit 26, a communication control unit 27, a display control unit 28, and an image processing unit 30.

The video acquisition unit 21 acquires an image output from the laptop computer 6 connected to the display apparatus 2 via a cable. Further, the video acquisition unit 21 analyzes the acquired image and extracts image information including resolution and update frequency of an image frame. The image information is output to an image acquisition unit 31 of the image processing unit 30.

When an electronic pen 4 or a hand of a user touches a display, the coordinate detection unit 22 detects position coordinates of the touch as a position where an event has occurred. The detection result is output to the event classification unit 25.

The automatic adjustment unit 23 is automatically activated when the power of the display apparatus 2 is turned on. The automatic adjustment unit 23 adjusts a parameter of the contact sensor 115 so that the contact sensor 115 outputs an appropriate value to the coordinate detection unit 22.

The contact detection unit 24 receives, from the electronic pen 4, a signal indicating that the front end or the rear end of the electronic pen 4 is pressed against the screen, thereby detecting whether or not the front end or the rear end of the electronic pen 4 is pressed against the screen. The detection result is output to the event classification unit 25.

The event classification unit 25 determines the type of the event based on the position coordinates detected by the coordinate detection unit 22 and the detection result of the contact detection unit 24. The events here include “stroke input,” “text input,” “user interface (UI) operation,” and “table operation.” The position coordinates detected by the coordinate detection unit 22 and the detection result of the contact detection unit 24 are also referred to as “event information.” The event classification unit 25 outputs the event information to a stroke processing unit 32, a text processing unit 35, a table processing unit 33, or the operation processing unit 26 based on the detection result of the event.

The operation processing unit 26 receives event information determined as “UI operation,” and requests the image processing unit 30 to perform processing corresponding to the element of the UI in which the event has occurred. UI is an acronym of user interface, and mainly refers to menus and buttons. The UI operation includes various operations such as changing the color of handwritten object, enlargement/reduction, table operation, and menu transition for the UI.

The communication control unit 27 controls communication with another display apparatus 2, a PC, a server, or the like via a communication network. The display control unit 28 displays the image generated by a display superimposing unit 38 on the display. The image may include a UI, a character string, a handwritten object, a table, an image, and a background.

The image processing unit 30 has the following functions. The image processing unit 30 includes the image acquisition unit 31, the stroke processing unit 32, the table processing unit 33, a table attribute memory 34, the text processing unit 35, a UI image generation unit 36, a background generation unit 37, the display superimposing unit 38, a page processing unit 39, a page data memory 40, a file processing unit 41, a license management unit 42, and layout management unit 43. Details are to be described later.

The image acquisition unit 31 acquires, as an image, frame information included in the video acquired by the video acquisition unit 21, and outputs the frame information to the display superimposing unit 38 and the page processing unit 39.

The stroke processing unit 32 receives event information determined as “stroke input,” and performs drawing of stroke data, and deletion or editing of drawn stroke data. The result of each operation is output to the display superimposing unit 38 and the page processing unit 39.

The table processing unit 33 receives event information discriminated as “table operation” and generates a table. In addition, the table processing unit 33 deletes a character string or handwritten data already drawn in the table and generates a character string corresponding to the attribute. The result of each operation is output to the display superimposing unit 38 and the page processing unit 39. The image processing unit 30 includes a table attribute memory 34 that stores the attributes of the table. The attributes of the table include an attribute of the entire table and an attribute of a cell. The table attribute memory 34 stores an initial value of each attribute. The initial value is an attribute that is set in advance without being set by the user. The attributes of the table will be described with reference to Tables 3 and 4.

The table processing unit 33 converts (character recognition processing) handwritten data in a table into a character string by character recognition. In addition, the table processing unit 33 changes, as a part of formatting, for example, a font of a character string displayed in the table into another font in accordance with the table attribute.

The text processing unit 35 receives event information determined as “text input” and generates a character string. Text input refers to inputting one or more characters with a software keyboard. In addition, the text processing unit 35 deletes and edits a character string already displayed. The result of each operation is output to the display superimposing unit 38 and the page processing unit 39.

The UI image generation unit 36 generates a UI image set in advance and outputs the UI image to the display superimposing unit 38. Examples of the UI image include menus and buttons with which the user performs various settings.

The background generation unit 37 receives, from the page processing unit 39, medium data included in page data read by the page processing unit 39 from the page data memory 40. The background generation unit 37 outputs the medium data to the display superimposing unit 38. The media data represents the background.

The layout management unit 43 stores layout information of images output from the image acquisition unit 31, the stroke processing unit 32, the table processing unit 33, the UI image generation unit 36, and the background generation unit 37. The layout information indicates, for example, the overlapping order and whether to display each layer. The layout information is output to the display superimposing unit 38.

The display superimposing unit 38 determines, based on the layout information output from the layout management unit 43, a layout of the respective images output from the image acquisition unit 31, the stroke processing unit 32, the table processing unit 33, the UI image generation unit 36, and the background generation unit 37.

The page processing unit 39 combines, into one page, data related to stroke data, text data, and table data; and video data from a PC. The page processing unit 39 stores the combined data in the page data memory 40. The page data memory 40 stores page data. The page data stored in the page data memory 40 will be described with reference to Tables 1 and 2.

The file processing unit 41 converts a PDF file read from the USB memory 5 into an image. The file processing unit 41 generates a PDF file from the displayed image. The license management unit 42 manages a license related to the use of the display apparatus 2.

Table 1 schematically illustrates object information stored in the page data memory 40.

TABLE 1

| Object Id | Type | Page | Coordinates | Size |
|---|---|---|---|---|
| 1 | Handwriting | 1 | x1, y1 | W1, H1 |
| 2 | Table | 1 | x2, y2 | W2, H2 |
| 3 | Graphic | 1 | x3, y3 | W3, H3 |
| 4 | Image | 2 | x4, y4 | W4, H4 |
| 5 | Graphic | 3 | x5, y5 | W5, H5 |
| 6 | Text | 4 | x6, y6 | W6, H6 |
| 7 | Image | 4 | x7, y7 | W7, H7 |

The drawing object information is information for controlling various drawing objects displayed by the display apparatus 2.

“Object identifier (ID)” is identification information identifying a drawing object. “Object” refers to any of various objects displayed on the screen.

“Type” is the type of the object. Examples of the object type include table (row or column), handwriting, character, graphic, and image.

“Table” represents a table object.

“Handwriting” represents stroke data (coordinate point sequence).

“Text” represents a character string (character codes) converted from handwritten data. A character string may be referred to as text data.

“Graphic” is a geometric shape, such as a triangle or a tetragon, converted from handwritten data.

“Image” represents image data in a format such as Joint Photographic Experts Group (JPEG), Portable Network Graphics (PNG), or Tagged Image File Format (TIFF) acquired from, for example, a PC or the Internet. Data of each object is stored in association with an object ID.

“Coordinates” represent the start point of the object with reference to a predetermined origin on the screen of the display apparatus 2. The start point of the drawing object is, for example, the upper left apex of the circumscribed rectangle of the drawing object. The coordinates are expressed, for example, in units of pixels of the display.

“Size” is the size (width and height) of the object. The end point position may be recorded.

Table 2 presents detailed information of the table.

TABLE 2

| | Column 1 | Column 2 | Column 3 |
|---|---|---|---|
| Row 1 | Coordinates | Coordinates | Coordinates |
| | (x11, y11) | (x12, y12) | (x13, y13) |
| | Size W11, H11 | Size W12, H12 | Size W13, H13 |
| Row 2 | Coordinates | Coordinates | Coordinates |
| | (x21, y21) | (x22, y22) | (x23, y23) |
| | Size W21, H21 | Size W22, H22 | Size W23, H23 |

The table object is stored in association with an object ID and the table. One table has cells identified by the row number and the column number. A cell is an area of a table delimited by rows and columns. The detailed information includes coordinates and a size for each cell. Since the position of an object such as stroke data is known as presented in Table 1, the particular cell that contains the object is known.

Table 3 presents entire table attributes stored in the table attribute memory 34.

TABLE 3

| Attribute name | Description | Value |
|---|---|---|
| Row number | Number of rows | Integer |
| Column number | Number of columns | Integer |
| Format at input | Whether to format | True/False |
| | object at the time | |
| | of input | |

The term “entire table attributes represent attributes related to the entire table. Each table has the attributes of Table 3.

“Row number” is the number of rows.

“Column number” is the number of columns.

“Format at input” is setting of whether the display apparatus 2 performs formatting in accordance with the table attribute in response to (e.g., immediately after) input of a character string or handwritten data by the user. In a case where the value of “format at input” is true, the display apparatus 2 performs formatting (including character recognition processing of handwritten data) of handwritten data or a character string. However, when “automatic character recognition conversion” in Table 4 is off (false), the character recognition processing is not automatically performed.

Table 4 presents cell attributes stored in the table attribute memory 34.

TABLE 4

| Attribute name | Description | Value |
|---|---|---|
| Font | Set font | MSP Mincho, |
| | | MS Gothic, etc. |
| Font size | Set font size | Integer |
| Color | Set color | RGB values |
| Background color | Set background color | RGB values |
| Alignment | Set alignment | |
| Automatic character | Convert stroke to | True/False |
| recognition conversion | text object | |
| Auto-adjust cell | enlarge cell to | True/False |
| size to text | match input text | |
| Title | Title or not | True/False |

The cell attribute is an attribute relating to a cell. Each cell in a table has the attributes of Table 4. Cells of a table may have the same attributes.

“Font” is the font of the character string displayed in the cell.

“Font size” is the size of the character string displayed in the cell.

“Color” is the color of a character string displayed in the cell.

“Background color” is the color of the cell.

“Alignment” is the position of the character string in the cell (e.g., right alignment, left alignment, lateral center alignment, top alignment, bottom alignment, or vertical center alignment).

“Automatic character recognition conversion” is setting of whether to automatically convert handwritten data into a character string. The term “automatically” means that, when a certain period of time has elapsed after the electronic pen 4 is separated from the display, character recognition is executed even if the user does not input an character recognition start operation.

“Auto-adjust cell size to text” is setting of whether to automatically adjust the cell size to match the size of text (character string) in the cell, that is, the number of characters in the cell multiplied by the size of one character.

“Title” is the setting of whether the cell is a title cell. For a title cell, the font, the background color, and the like may be set based on an attribute for the title.

Operation Detected as Event

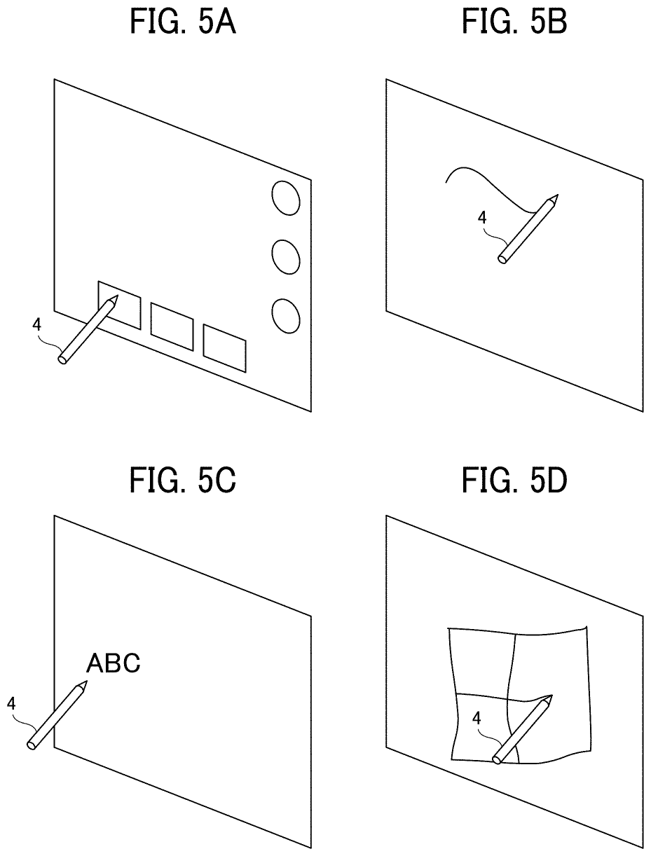

Next, a description is given below of an event detected by the display apparatus 2, with reference to FIGS. 5A to 5D. FIGS. 5A to 5D are diagrams illustrating an operation detected as an event.

FIG. 5A is a diagram illustrating a UI operation event. A “UI operation event” is defined as an event detected when the user presses a predetermined position on the screen with the electronic pen 4 or a finger in a state where the UI is displayed on the screen. The display apparatus 2 allows the user to change the color and the width of ink of the electronic pen 4 by operating the UI. Further, the display apparatus 2 allows the user to switch input between stroke data, text data, and table data by a UI operation.

FIG. 5B is a diagram illustrating a stroke input event. A “stroke input event” is defined as an event detected when the user performs a series of operations of pressing the electronic pen 4 (or input device) against the screen, moving the electronic pen 4 in the pressed state, and then releasing the electronic pen 4 from the screen. The stroke input event further includes an event in which the user instructs the display apparatus 2 to delete or move an already arranged character string.

FIG. 5C is a diagram illustrating a text operation event. A “text operation event” is an event detected when the user inputs data represented by one or more character codes, such as a character string, using a software keyboard or the like. The text operation event further includes an event in which the user instructs the display apparatus 2 to delete or edit a character string already arranged.

FIG. 5D is a diagram illustrating a table operation event. A “table operation event” is defined as an event detected when the user inputs a table, or inputs handwritten data or a character string in a table. For example, when stroke data is handwritten and superimposed on a rectangular graphic, the event classification unit 25 determines that the operation is a table operation event. Then, the table processing unit 33 divides and convert the rectangle into table data (details will be described later). Similarly, the event classification unit 25 determines input of handwritten data to the table based on the coordinates of the handwritten stroke data. Then, the table processing unit 33 formats the handwritten data according to the attribute. The table operation event also includes an event detected when the user operates (moves, enlarges/reduces, or deletes) an already displayed table.

Inputting Table

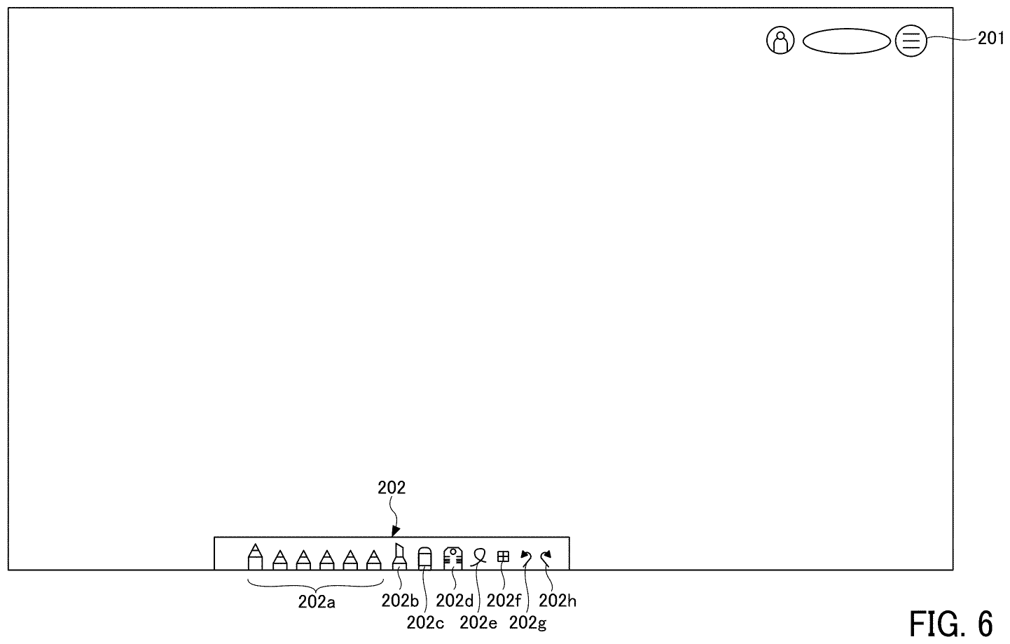

FIGS. 6 to 8 are diagrams illustrating a method for inputting a table on the display apparatus 2. FIG. 6 is a diagram illustrating an example of the UI of the display apparatus 2. The display apparatus 2 includes, as the UI, a setting button 201 and a drawing panel 202. The setting button 201, which will be described later, is a button for the user to set initial values of attributes of the table.

The drawing panel 202 includes buttons such as a pen color button 202a, a marker button 202b, an eraser tool button 202c, a rule button 202d, a handwriting input button 202e, a table creation button 202f, an undo button 202g, and a redo button 202h.

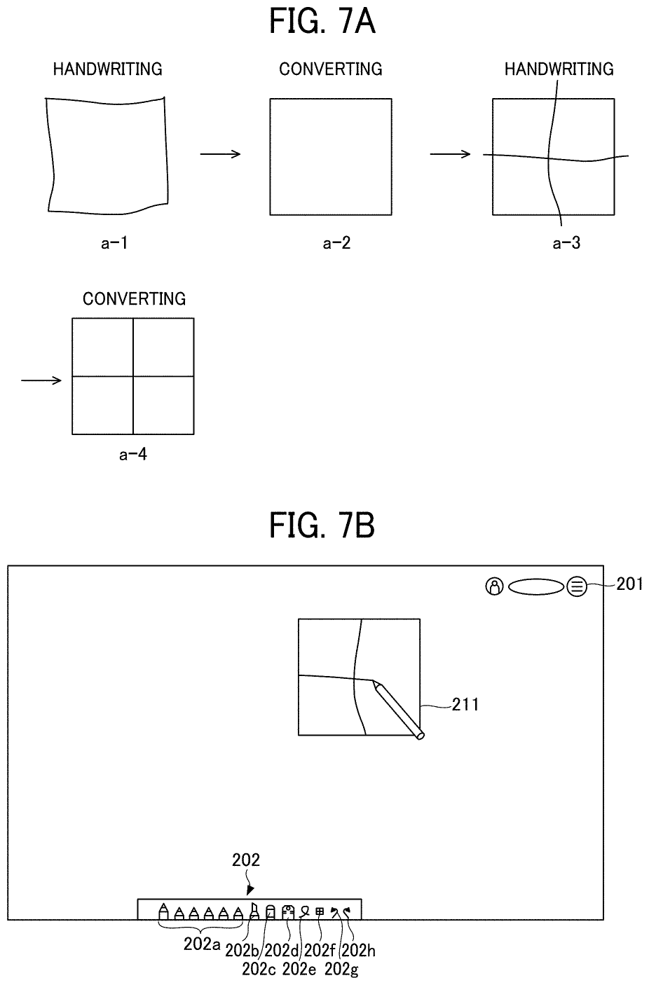

FIGS. 7A and 7B illustrate an example of a table 211 handwritten on the display by the user. Examples of the detection method of the table 211 include a method of determining a shape (FIG. 7A) and a method of detecting an intersection of straight lines (FIG. 7B).

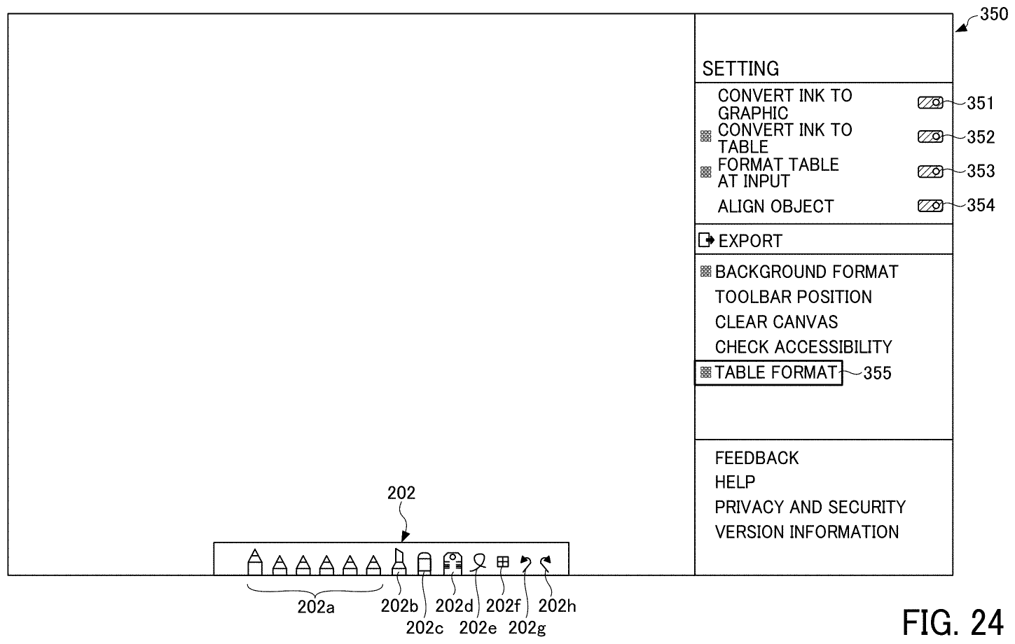

In the method of determining the shape, it is assumed that an on/off slide button 351 (see FIG. 24) for “convert ink into graphic” described later is on. The event classification unit 25 detects the rectangular shape by pattern matching or machine learning (state a-1 of FIG. 7A). The display control unit 28 displays a rectangular graphic (state a-2 of FIG. 7A). When a straight line is handwritten and superimposed on the rectangle (state a-3 of FIG. 7A), the event classification unit 25 determines that the event is a table operation event and formats the table (state a-4 of FIG. 7A). In a case where the user creates a table based on a rectangle, turning on the table creation button 202f is not necessary (but may be turned on).

To convert a plurality of straight lines into a table, the user turns on an on/off slide button 352 labelled as “convert ink into table” (see FIG. 24) to be described later. Alternatively, it is preferable to turn on the table creation button 202f. This is because the user may want to keep the stroke data as is. In the method of detecting the intersection of straight lines, the event classification unit 25 classifies stroke data into horizontal lines and vertical lines, and detects intersections. The event classification unit 25 assigns intersection numbers to the intersections on the horizontal lines from the left (or from the right), and determines whether or not the respective intersections of the horizontal lines assigned with the same intersection number have a substantially same X coordinate. The event classification unit 25 assigns intersection numbers to the intersections on the vertical lines from the top (or from the bottom), and determines whether or not the respective intersections of the vertical lines assigned with the same intersection number have a substantially same Y coordinate. When the intersections are substantially the same in X coordinate and Y coordinate, the event classification unit 25 detects a table operation event.

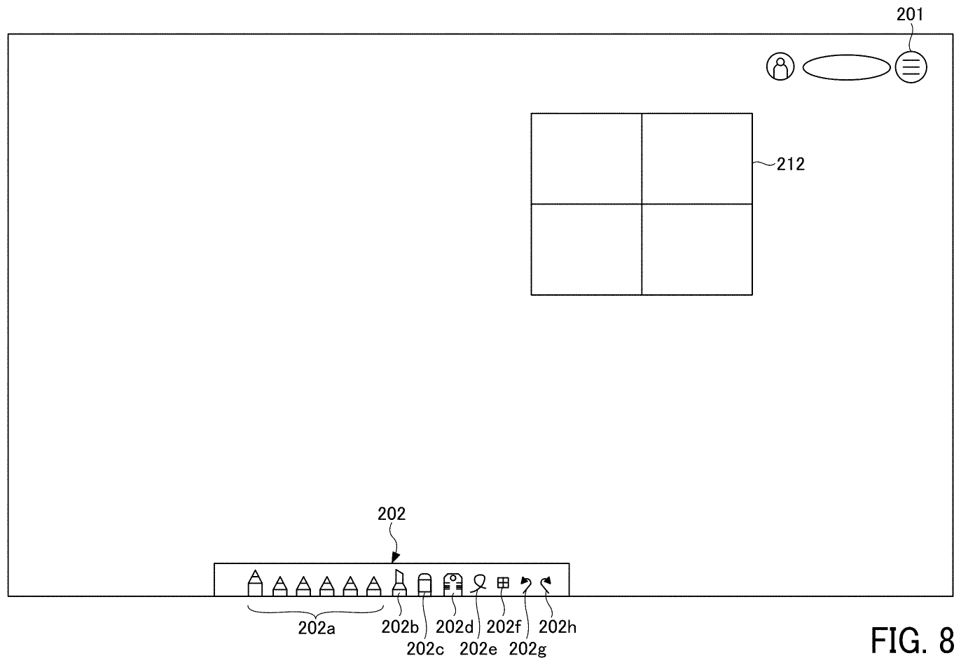

FIG. 8 is a diagram illustrating a table 212 that has been cleared by the table processing unit 33. In the method in which initially the rectangle is displayed, the table processing unit 33 deletes the stroke data superimposed on the table, and divides the rectangle based on the coordinates of the stroke data, to create the table 212.

In the method of detecting a plurality of straight lines, the table processing unit 33 erases the stroke data defining the table 211, and displays the table 212 that has been formatted based on the stroke data. The table processing unit 33 obtains, for example, a circumscribed rectangle of all stroke data detected as a table operation event, and divides the circumscribed rectangle by the number of horizontal lines and vertical lines of the stroke data. The positions of the horizontal line and the vertical line are determined based on the intersections.

In this way, the table is formatted. However, conventionally, when a plurality of persons inputs handwriting on the table, the table may have a poor visibility.

Note that, in FIGS. 7 and 8, the table handwritten by the user is converted into a formatted table, but alternatively, a formatted table may be generated. That is, when the user instructs the display apparatus 2 to display a table specifying the number of rows and the number of columns, a table having cells of a certain height and a certain width is displayed. The display apparatus 2 allows the user to freely change the height and width of the displayed table.

Example of Formatting in Accordance with Attributes of Table

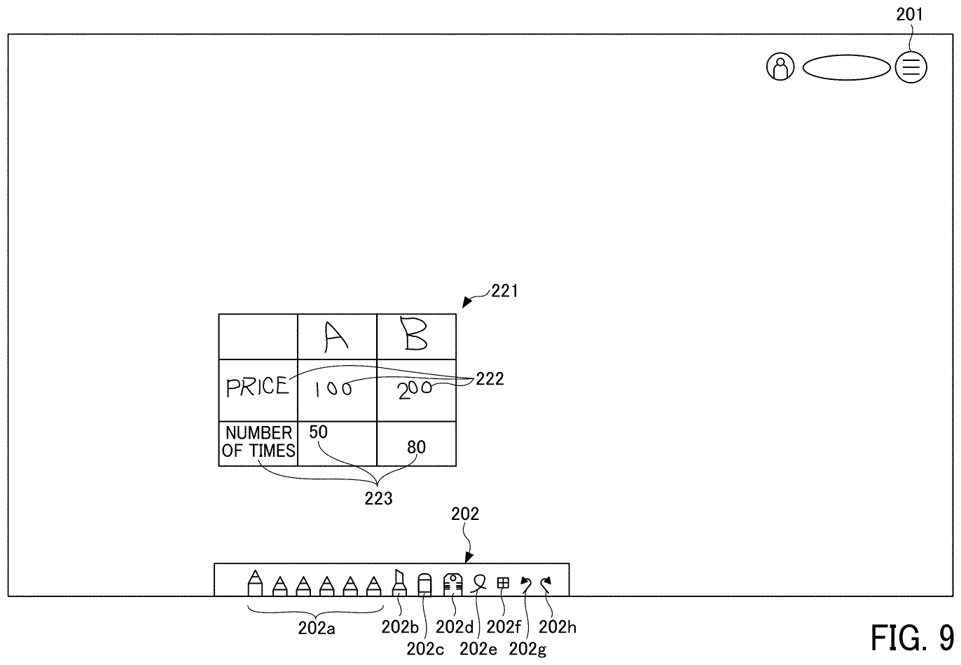

Next, with reference to FIGS. 9 to 12, a description will be given of formatting in accordance with a table attribute. FIG. 9 illustrates handwritten data 222 and character strings 223 input inside a formatted table 221. In FIG. 9, the handwritten data 222 and the character strings 223 are mixed in one table 221.

As an example method for inputting the character strings 223 in the table, the user specifies a cell with the electronic pen 4 and inputs the desired character string 223 with a software keyboard. In another method, the user inputs the desired character string 223 with a software keyboard and then moves the character string 223 to a desired cell. In FIG. 9, the respective positions of the character strings 223 differ depending on the cell.

When the user wants to format the handwritten data in the table 221, the user holds down the electronic pen 4 on the table 221. The event classification unit 25 determines that the event is a UI operation event based on the coordinates pressed by the electronic pen 4, and notifies the operation processing unit 26 of the event. Since the table 221 is held down with the electronic pen 4, the operation processing unit 26 requests the UI image generation unit 36 to provide a menu for table operation. The UI image generation unit 36 displays the menu for table operation.

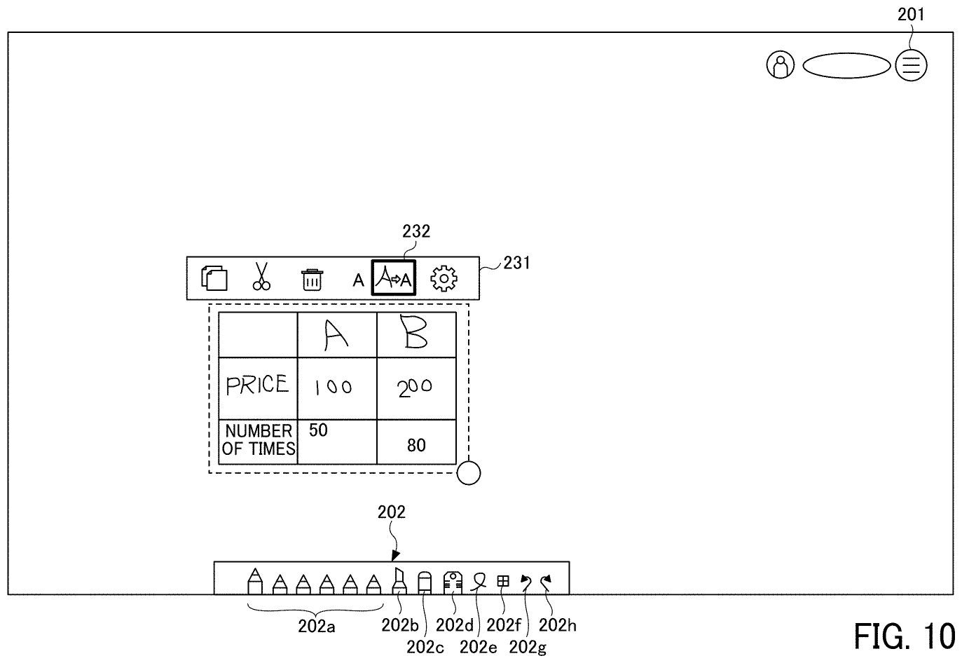

FIG. 10 illustrates an example of a table operation menu 231. The table operation menu 231 includes a table format button 232, which is an example of graphical representation for formatting a table. The table format button 232 is a button for the user to instruct the display apparatus 2 whether to format the handwritten data 222 and the character strings 223 input to the table. That is, the object to be formatted may be handwritten data or a character string. In the case of the handwritten data 222, the conversion includes character recognition-based conversion and formatting based on the table attribute. In the case of the character string 223, conversion includes the formatting, which is changing appearance of the character string 223 in accordance with the table attribute (changing the font or the like).

Since the pressing of the table format button 232 is a UI operation event, the event classification unit 25 notifies the operation processing unit 26 that the table is to be formatted. The operation processing unit 26 requests the table processing unit 33 to format the table.

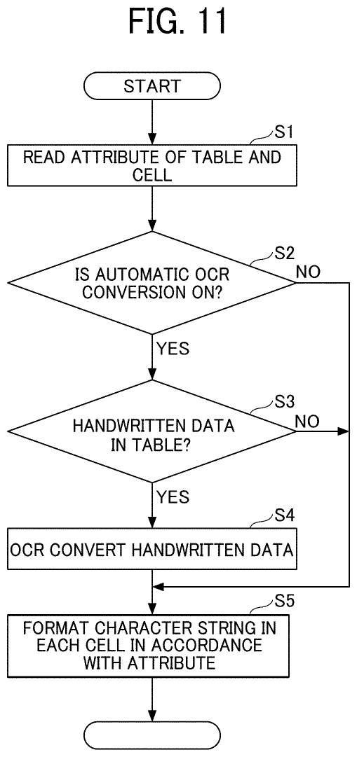

FIG. 11 is an example of a flowchart illustrating a process performed by the display apparatus 2 when the table format button 232 is pressed. The display apparatus 2 executes the process in FIG. 11 when the attribute “format at input” as to the entire table is true or when the user operates the table format button 232 from the menu.

The table processing unit 33 acquires the attributes of the table selected by the user (entire table attributes and the cell attributes) from the table attribute memory 34 (S1).

The table processing unit 33 determines whether or not the cell attribute “automatic character recognition (CR) conversion (handwritten data to character strings)” is true (S2).

When the determination of step S2 is Yes, the table processing unit 33 determines whether or not there is handwritten data in the table (S3). The type (e.g., stroke data, character string, or image) and coordinates of each data input to the display apparatus 2 are stored in the page data memory 40.

Based on the determination that the table includes handwritten data, the table processing unit 33 converts the handwritten data into a character string by character recognition (S4). In the case where the table attribute “format at input” is true, step S4 is executed when a certain period of time has elapsed from when the user separates the electronic pen 4 (or, for example, the user's hand) from the display.

Then, the table processing unit 33 formats the character string of each cell (S5) in accordance with the table attribute. That is, the table processing unit 33 changes the font, font size, color, and layout of the character string, and background color of the cell in accordance with the cell attribute. For example, when a character string input using a soft keyboard is moved from outside the table to a cell of the table, such a character string may have a font size different from the table attribute. Appearance of such a character string is also changed in accordance with the table attribute in the formatting. The table processing unit 33 converts handwritten data into a character string, and further converts the character string in accordance with the attribute associated with the table.

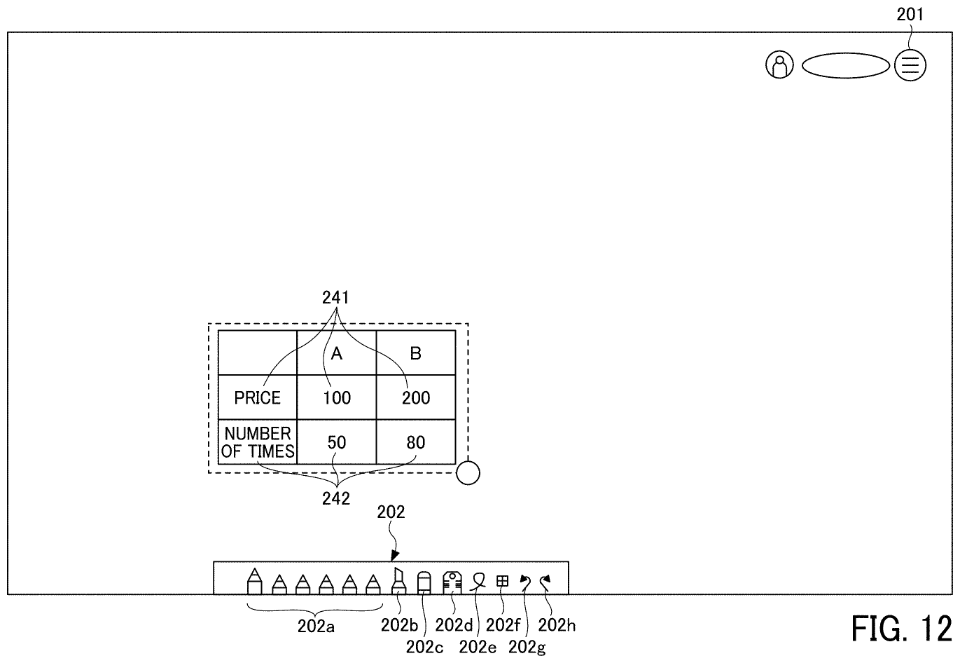

FIG. 12 illustrates an example of a formatted table on the display by the above processing. Compared with FIG. 9, the plurality of handwritten data 222 in FIG. 9 has been converted into a plurality of character strings 241. The plurality of character strings 223 in FIG. 9 has been converted into a plurality of formatted character strings 242. By the formatting, the respective character strings 241 and 242 in the cells have the same size, and the positions in the horizontal direction and the vertical direction in the cells are also aligned with the center.

As described above, the display apparatus 2 according to the present embodiment formats handwritten data and character strings input to the table in accordance with the table attribute.

Attribute Setting

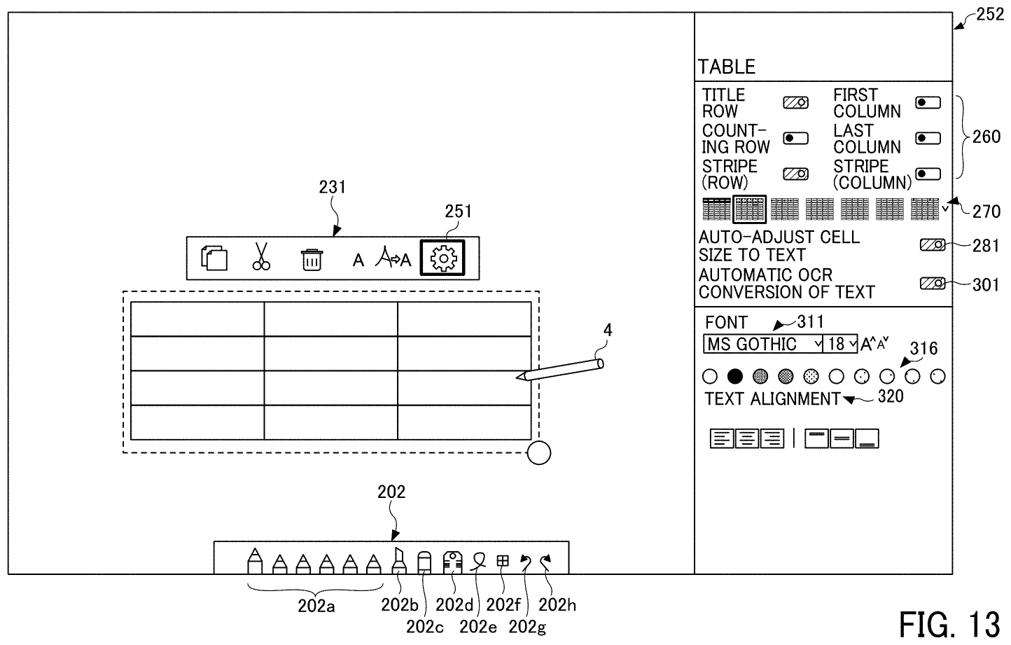

Next, with reference to FIGS. 13 to 21, the change of the table attribute or the cell will be described. FIG. 13 is a diagram illustrating setting of an attribute of a table. As illustrated in FIG. 13, when the user holds down the frame of the table with the electronic pen 4, the UI image generation unit 36 (see FIG. 4) displays the table operation menu 231 via the event classification unit 25 and the operation processing unit 26.

The table operation menu 231 includes a table setting button 251. In response to pressing by the user of the table setting button 251, a table setting screen 252 is displayed by the UI image generation unit 36, the display control unit 28, and the like. The table setting screen 252 is for receiving set values of the table attributes. The table setting screen 252 includes a group of on/off slide buttons 260, a list 270 of table design, an on/off slide button 281, an on/off slide button 301, a font setting field 311, a color palette 316, and an alignment setting field 320. The table setting screen 252 will be described in detail below.

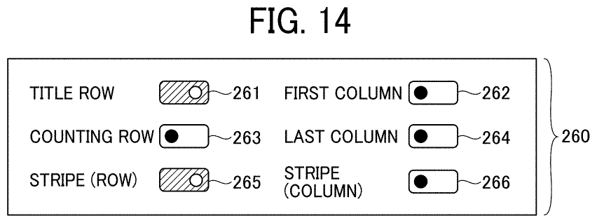

FIG. 14 is a first diagram illustrating details of the table setting screen 252. FIG. 14 illustrates respective on/off slide buttons assigned to item names, included in the group of on/off slide buttons 260. A title row button 261 is an on/off slide button for the user to instruct the display apparatus 2 whether to set the first row as the title row. A first column button 262 is an on/off slide button for the user instruct the display apparatus 2 whether to set the first column as the title column. A counting row button 263 is an on/off slide button for the user to instruct the display apparatus 2 whether to set the last row as a counting row. A last column button 264 is an on/off slide button for the user to instruct the display apparatus 2 whether to set the last column as a counting column. A stripe (row) button 265 is an on/off slide button for the user to instruct the display apparatus 2 whether to stripe the title row. A stripe (column) button 266 is an on/off slide button for the user to instruct the display apparatus 2 whether to stripe the title column.

In this manner, the display apparatus 2 allows the user to change the cell attributes associated with the title. The cell attribute “title” is changed in accordance with the setting illustrated in FIG. 14, made by the user.

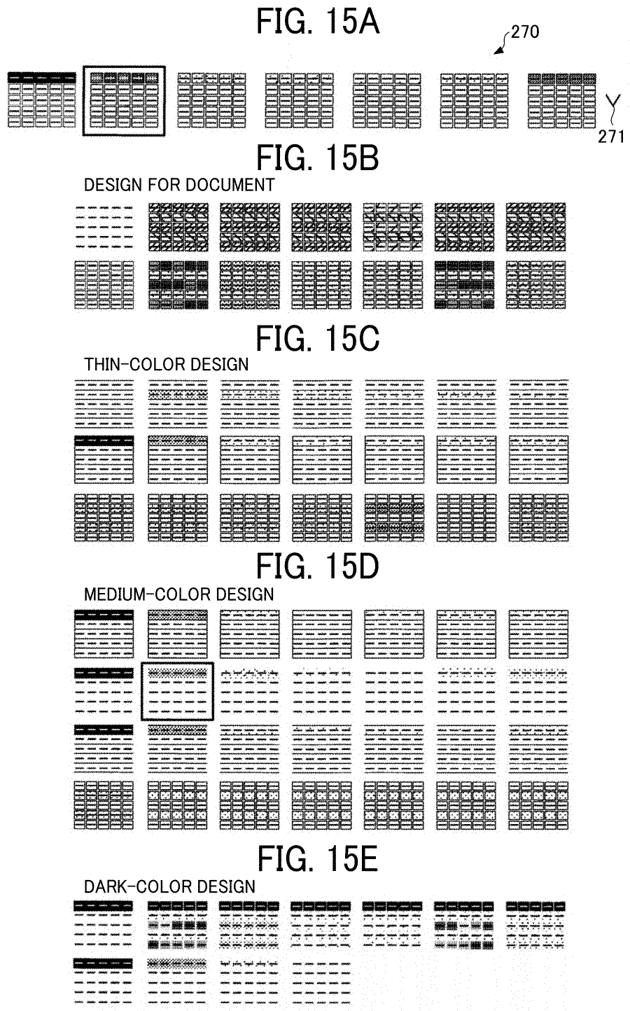

FIGS. 15A to 15E are second diagrams illustrating details of the table setting screen 252. FIG. 15A illustrates the list 270 of table designs. For convenience of drawing, FIG. 15A is in black and white, but table designs have color schemes of monochrome, blue, red, gray, yellow, light blue, and green. The list of table designs has a pull-down menu 271. When the user presses the pull-down menu 271, a list of designs illustrated in FIGS. 15B to 15E is displayed. FIG. 15B illustrates a design suitable for a document. FIG. 15C illustrates a light color design, FIG. 15E illustrates a medium color (as darkness of color) design, and FIG. 15E illustrates a dark color design.

The color of the cell attribute and the background color are changed according to the table design selected by the user in FIGS. 15A to 15E.

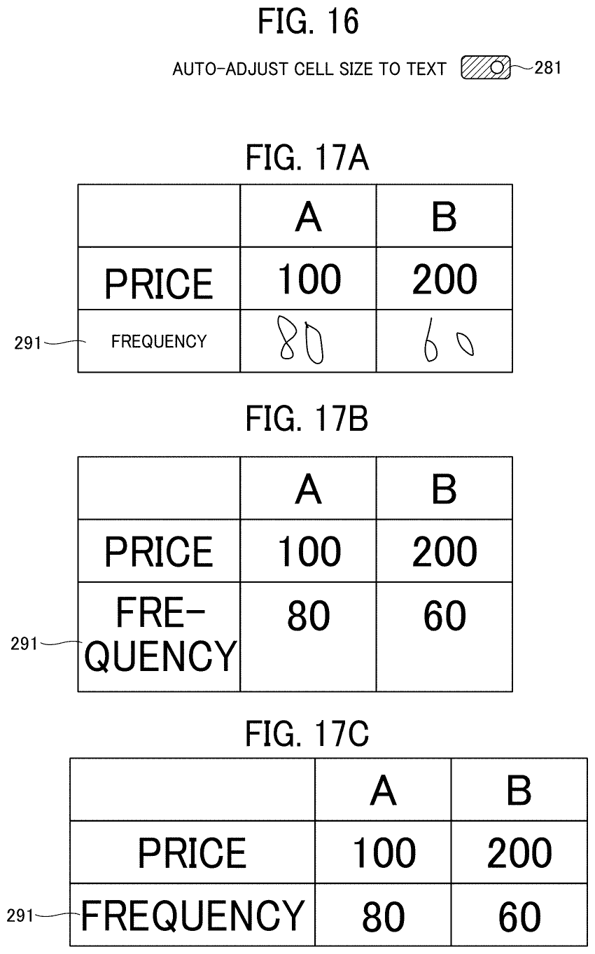

FIG. 16 is a third diagram illustrating details of the table setting screen 252. FIG. 16 illustrates the on/off slide button 281 associated with “auto-adjust cell size to text.” The on/off slide button 281 is a button for the user to instruct the display apparatus 2 whether to automatically adjust the cell size to fit the text (character string) in the cell.

FIGS. 17A to 17C are diagrams illustrating adjustment of the cell size using the on/off slide button 281 labelled as “auto-adjust cell size to text.” FIG. 17A illustrates a table before formatting, and FIG. 17B illustrates a table after formatting. In the example illustrated in FIG. 17A, when the size of the character string in the lower left cell of FIG. 17A is changed according to the attribute of the cell, the cell does not accommodate the entire character string.

When the on/off slide button 281 for auto-adjust cell size to text is off (false), the table processing unit 33 does not enlarge the cell to fit the text size. “Enlarge” refers to increasing the lateral width of the cell. As illustrated in FIG. 17B, the character string 291 “frequency” is arranged in two lines, and the height of the cell is increased to accommodate the two lines.

FIG. 17C illustrates a formatting example when the on/off slide button 281 for auto-adjust cell size to text is on (true). When “auto-adjust cell size to text” is true, the table processing unit 33 enlarges the cell in accordance with the size of the text. As illustrated in FIG. 17C, the width of the cell is increased to accommodate the character string 291 “frequency” in one line.

Since the size (vertical size and horizontal size) of the text depends on the font and character type (e.g., Japanese, alphabet, or number), the table processing unit 33 compares the total size of the text with the cell size, and determines whether to execute line feed or size change according to the setting of “auto-adjust cell size to text.” When a line feed is preferred, a table processing unit 33 determines the number of lines based the number of characters accommodated in one line and the total number of characters, calculates the height of the cell to fit the determined number of lines, and corrects the height of the cell. When the line feed is not performed, the table processing unit 33 determines the horizontal length of the cell based on the total number of characters, and corrects the horizontal length of the cell.

The setting made by the user with the on/off slide button 281 in FIG. 16 is reflected in the cell attribute “auto-adjust cell size to text” and stored in the table attribute memory 34.

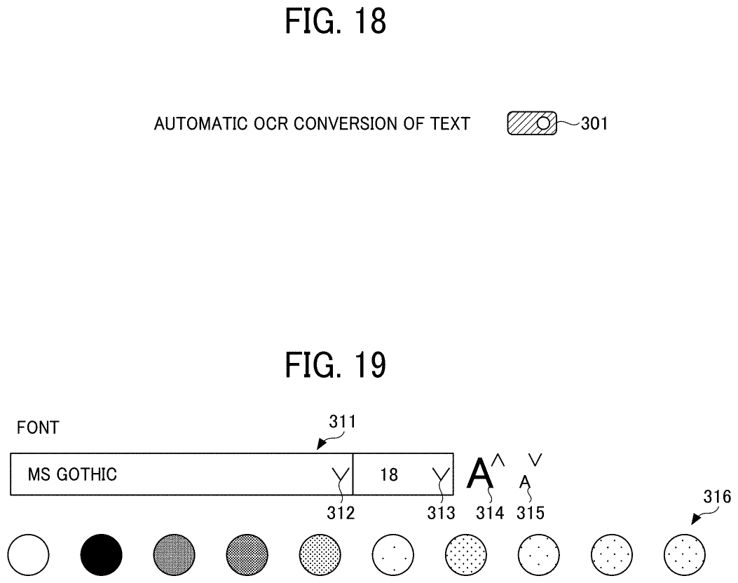

FIG. 18 is a fourth diagram illustrating details of the table setting screen 252. FIG. 18 illustrates an on/off slide button 301 associated with “automatic character recognition conversion.” The on/off slide button 301 is a button for the user to instruct the display apparatus 2 whether to automatically perform character recognition on the handwritten data in the cell.

Some users may not want to use character recognition because character recognition is not correct. When the user turns off the on/off slide button 301 associated with “automatic character recognition conversion,” the display apparatus 2 performs the position adjustment but does not perform character recognition.

The setting made by the user with the on/off slide button 301 in FIG. 18 is reflected to the cell attribute “automatic character recognition conversion” and stored in the table attribute memory 34.

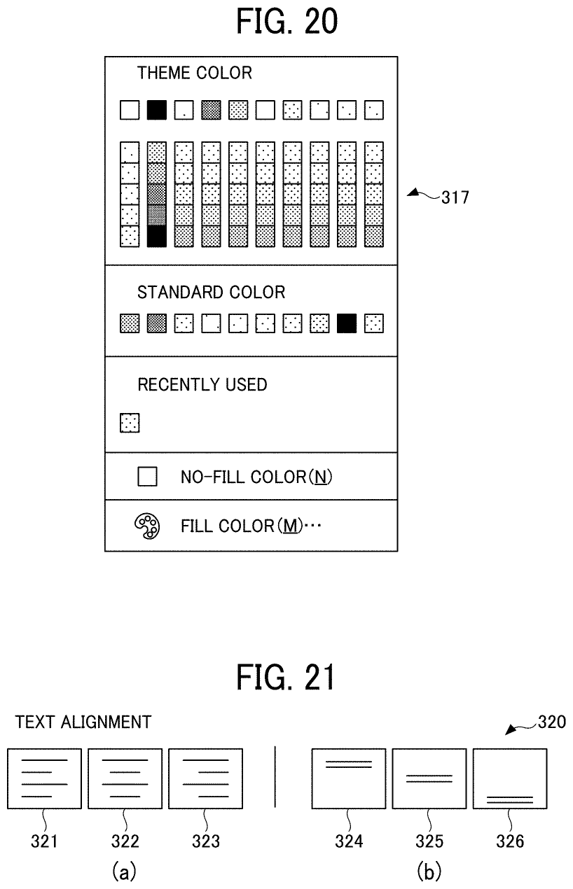

FIG. 19 is a fifth diagram illustrating details of the table setting screen 252. FIG. 19 illustrates a font setting field 311. A pull-down menu 312 allows the user to select a font. A pull-down menu 313 allows the user to select a character size. A large size button 314 is a button for the user to instruct the display apparatus 2 to increase the character size by one degree. A small size button 315 is a button for the user to instruct the display apparatus 2 to reduce the character size by one degree. A color palette 316 is a list of colors for the user to instruct the display apparatus 2 to set the character color. Alternatively, the display apparatus 2 may allow the user to select color from a color palette 317, as illustrated in FIG. 20.

The information set in FIG. 19 or 20 is set to the font, font size, and color of the cell attribute, respectively,” and stored in the table attribute memory 34.

FIG. 21 is a sixth diagram illustrating details of the table setting screen 252. FIG. 21 illustrates the alignment setting field 320 for character strings. A section (a) of FIG. 21 is a selection filed in which the user selects the alignment of character strings in the horizontal direction in a cell. The display apparatus 2 allows the user to select a left align icon 321, a center align icon 322, or a right align icon 323.

A section (b) of FIG. 21 illustrates a selection filed in which the user selects the alignment of character strings in the height direction in a cell. The display apparatus 2 allows the user to select a top align icon 324, a center align icon 325, or a bottom align icon 326. The information set in FIG. 21 is set to the cell attribute “alignment” and stored in the table attribute memory 34.

Setting of Cell Attribute

As described above, the display apparatus 2 allows the user to set an attribute common to cells and to set a cell attribute on an individual cell basis.

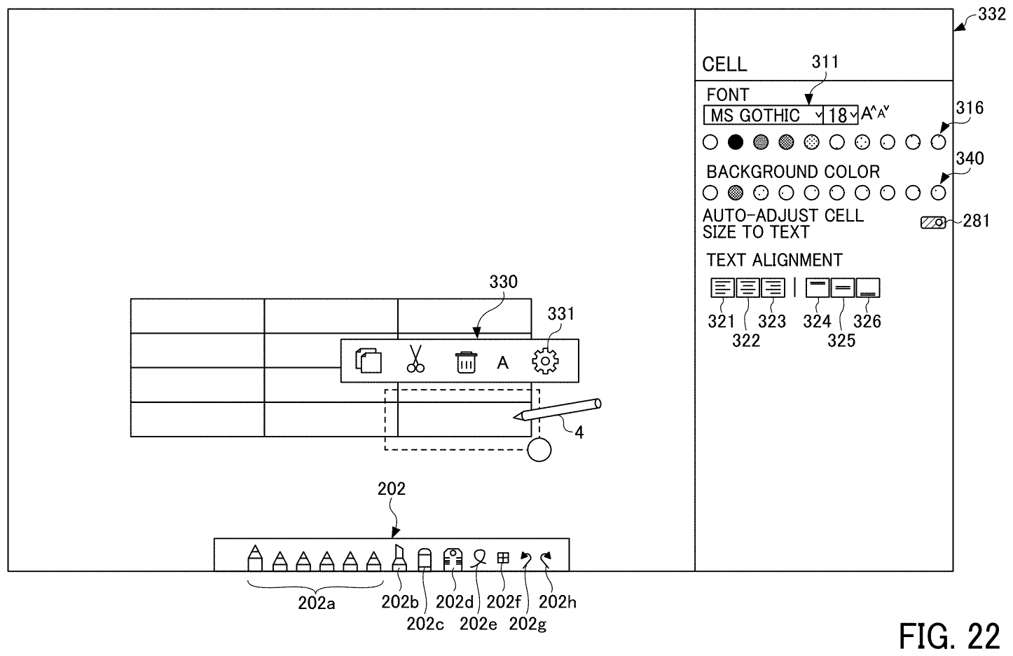

A description is given of setting attributes to individual cells with reference to FIG. 22. FIG. 22 illustrates an example of a cell attribute setting screen 332 for individually setting an attribute to a cell. When the user holds down a desired cell with the electronic pen 4, the UI image generation unit 36 displays a table operation menu 330. The table operation menu 330 includes a cell setting button 331. When the user presses the cell setting button 331, the cell attribute setting screen 332 for the cell selected by the user is displayed.

The cell attribute setting screen 332 includes items of “font,” “auto-adjust cell size to text,” and “text alignment.” The method for these settings may be the same as the method of the table setting screen 252 of FIG. 13. The method for setting background color with a button 340 may be the same as that with the color palette 316.

In this way, the display apparatus 2 allows the user to select cell and individually set different attributes to cells.

Setting of Initial Value

The display apparatus 2 has initial values of the attributes of the table in advance. In other words, even if the user does not set an attribute, the display apparatus 2 displays respective character strings in the cells in the same size and font, as formatting of the table.

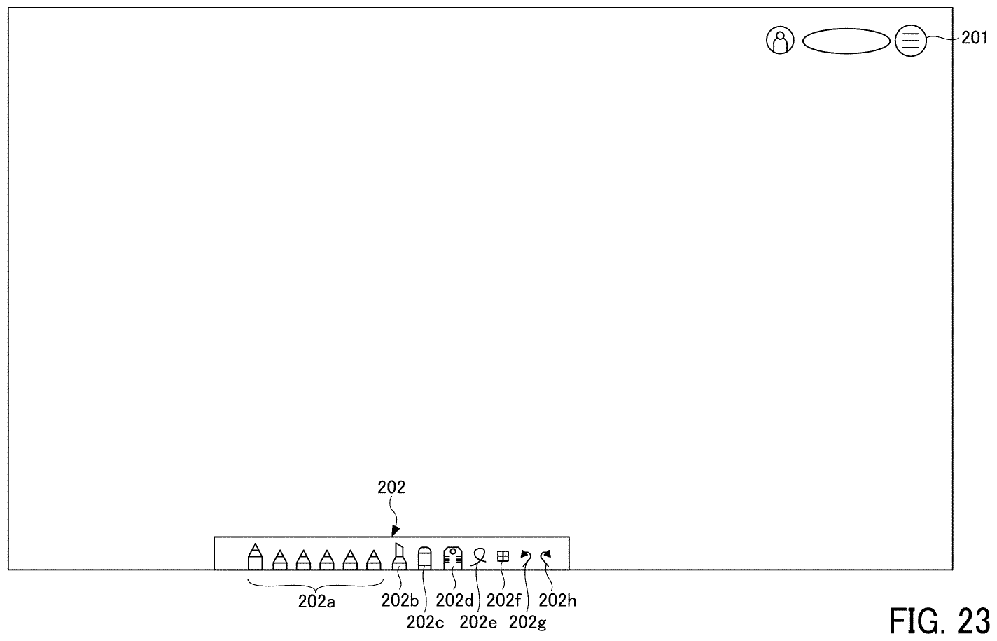

FIG. 23 illustrates a setting button 201 to be pressed by the user to set the initial value. FIG. 24 illustrates an example of a various settings screen 350 displayed in response to pressing of the setting button 201. A description is given below of items on the various setting screen 350. The on/off slide button 351 labeled as “convert ink to graphic” is a button for the user to set whether to convert handwritten data to a graphic. The on/off slide button 352 labeled as “convert ink to table” is a button for the user to set whether to convert handwritten data to a table. Which handwritten data is converted into a table is determined in advance. For example, as described with reference to FIGS. 7A and 7B, the event classification unit 25 detects a table by a shape determining method or an intersection detecting method using pattern matching or machine learning. A on/off slide button 353 labeled as “format table at input” is an on/off button for the user to instruct the display apparatus 2 to set on/off of the cell attribute “automatic character recognition conversion.” An on/off slide button 354 labelled as “align object” is a button for the user instruct the display apparatus 2 whether to align adjacent objects. A button 355 labelled as “table format” is a button for the user to set initial values of attributes of a table. When the user presses the button 355 labelled as “table format,” an initial value setting screen is displayed.

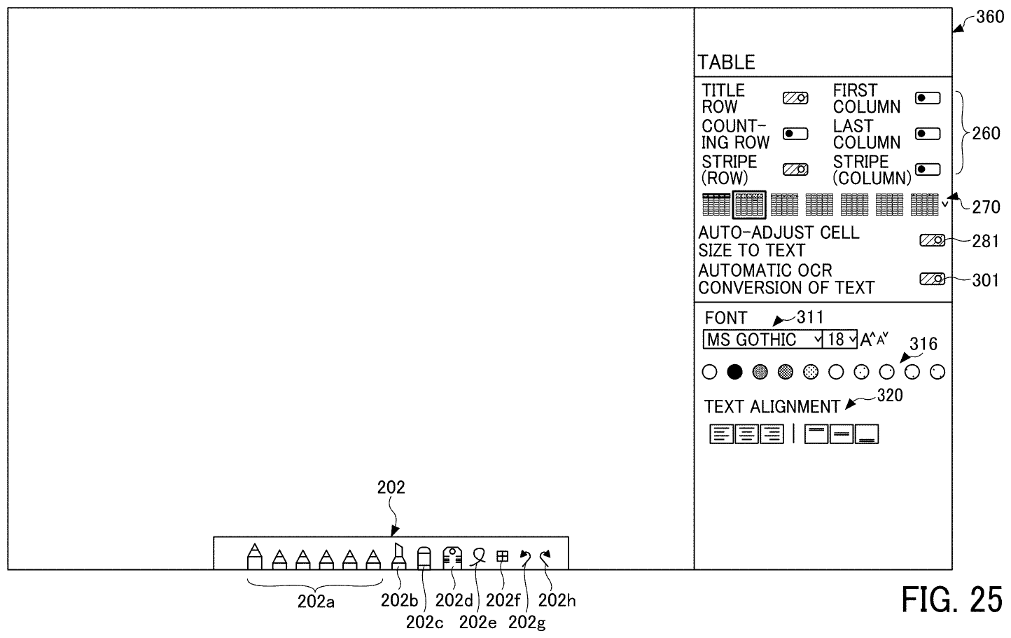

FIG. 25 illustrates an example of an initial value setting screen 360. The initial value setting screen 360 of FIG. 25 has a configuration similar to that of the table setting screen 252 of FIG. 13. The display apparatus 2 allows the user to set initial values of attributes of the table from the initial value setting screen 360.

A description will be given of the on/off slide button 353 labeled as “format table at input” on the various settings screen 350 in FIG. 24. In the case where the on/off slide button 353 labeled as “format table at input” is on, the table processing unit 33 formats the data in the table in accordance with the table attributes, in response to detection of the following operation. Input of handwritten data; Drop of handwritten data; Input of a character string; and Drop of a character string. That is, the display apparatus 2 formats the table in response to these user operations, without the intervention of user's operation for displaying and selecting the table format button. Note that conversion of handwritten data into a character string is executed when setting of “automatic character recognition conversion” is true (on).

As described above, the display apparatus 2 according to the present embodiment formats a table in accordance with an attribute set to the table. Accordingly, even when multiple users input handwriting having different appearances to a table, the display apparatus 2 displays a formatted table having a sense of unity. Then, the table has an improved visibility, thereby fostering discussion or the like using the table.

### Embodiment 2

In the present embodiment, a description is given below of a display system in which the display apparatus 2 and a communication terminal communicate with each other via a server and network.

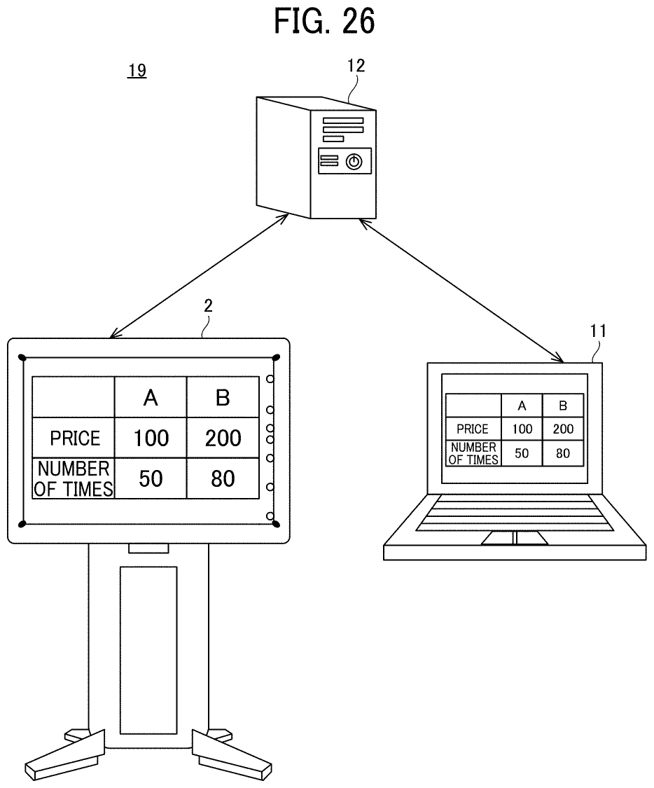

FIG. 26 is a schematic diagram illustrating an example of a configuration of a display system 19 according to the present embodiment. The display apparatus 2 and a communication terminal 11 are respectively connected to a server 12 via a network such as the Internet. The communication terminal 11 is any terminal, such as a general-purpose information processing terminal, on which a web browser or a dedicated application runs. Examples of the communication terminal 11 include a PC, a smartphone, a tablet terminal, a game console, a personal digital assistant (PDA), a wearable PC, and a car navigation system.

The functions of the display apparatus 2 may be the same as those of Embodiment 1 illustrated in FIG. 4, except that the display apparatus 2 communicates with the server 12. The communication control unit 27 (see FIG. 4) of the display apparatus 2 transmits object data (a table and character strings in the table) to the server 12. The server 12 transmits a uniform resource locator (URL) for a conference, to be commonly accessed by the display apparatus 2 and the communication terminal 11 to the display apparatus 2. The display apparatus 2 transmits the URL to the communication terminal 11 by e-mail or the like. Thus, the communication terminal 11 communicates with the server 12 and receives the object data transmitted from the display apparatus 2. When the communication terminal 11 displays an object using a web browser, the server 12 generates screen information using hypertext markup language (HTML) or the like. When the communication terminal 11 displays an object using a dedicated application, the server 12 may mainly transmit the object and coordinates thereof to the communication terminal 11 as screen information.

Further, in a case where the communication terminal 11 includes a touch panel, the communication terminal 11 receives input of handwritten data to a table from the user and formats the table in the same manner as the display apparatus 2. The object data after formatting is transmitted to the display apparatus 2 via the server 12 and the network.

As described above, in the display system 19, the display apparatus 2 and the communication terminal 11 interactively process a table. Accordingly, the same table, which is formatted according to the attribute, is shared between the display apparatus 2 and the communication terminal 11.

In the configuration illustrated in FIG. 26, alternatively, the server 12 may perform the processing performed by the display apparatus 2, for example, as described above referring to FIG. 11. In this case, the display apparatus 2 (or the communication terminal 11) displays the stroke data and transmits various events to the server 12. The server 12 performs formatting of the table, generates screen information of the display apparatus 2 after the formatting, and transmits the screen information to the display apparatus 2 and the communication terminal 11. The display apparatus 2 and the communication terminal 11 each display the formatted table, based on the screen information.

### Embodiment 3

Another example of the configuration of the display apparatus 2 will be described.

A description is given below of another example of the configuration of the display system.

Although the display apparatus 2 according to the present embodiment is described as that having a large touch panel, the display apparatus 2 is not limited thereto.

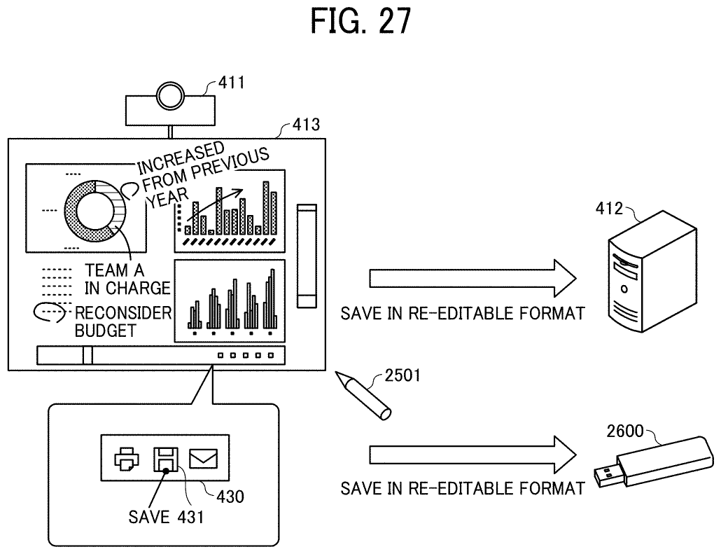

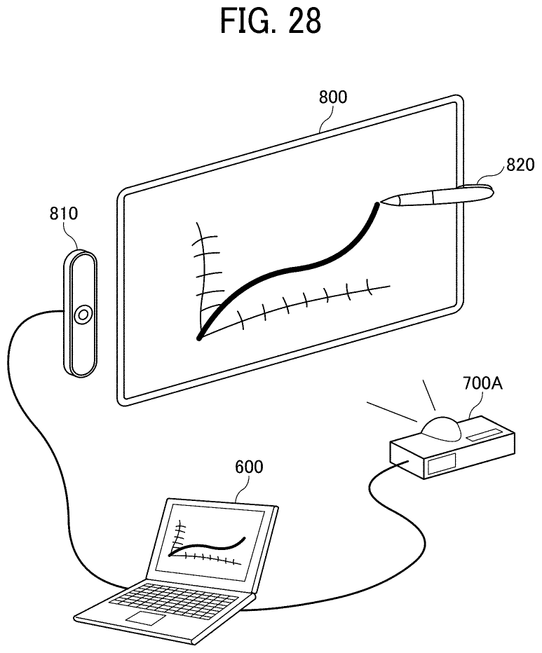

FIG. 27 is a diagram illustrating another example of the configuration of the display system. The display system includes a projector 411, a whiteboard 413, and a server 412, which are communicable via a network. In FIG. 27, the projector 411 is installed on the upper face of the standard whiteboard 413. The projector 411 mainly operates as the display apparatus 2 described above. The projector 411 is a general-purpose projector, but installed with software that causes the projector 411 to function as the functional units of the display apparatus 2 illustrated in FIG. 4. The “standard whiteboard” (the whiteboard 413) is not a flat panel display integral with a touch panel, but is a whiteboard to which a user directly handwrites information with a marker. Note that the whiteboard may be a blackboard, and may be simply a plane having an area large enough to project an image.

The projector 411 employs an ultra short-throw optical system and projects an image (video) with reduced distortion from a distance of about 10 cm to the whiteboard 413. This video may be transmitted from a PC connected wirelessly or by wire, or may be stored in the projector 411.

The user performs handwriting on the whiteboard 413 using a dedicated electronic pen 2501. The electronic pen 2501 includes a light-emitting element, for example, at a tip thereof. When a user presses the electronic pen 2501 against the whiteboard 413 for handwriting, a switch is turned on, and the light-emitting portion emits light. The wavelength of the light of the light-emitting element is near-infrared or infrared, which is invisible to the user's eyes. The projector 411 includes a camera. The projector 411 captures, with the camera, an image of the light-emitting element, analyzes the image, and determines the direction of the electronic pen 2501. Thus, the contact detection unit 24 (illustrated in FIG. 4), implemented by the camera, receives the light as the signal indicating that the electronic pen 4 is pressed against the screen. Further, the electronic pen 2501 emits a sound wave in addition to the light, and the projector 411 calculates a distance based on an arrival time of the sound wave. The projector 411 determines the position of the electronic pen 2501 based on the direction and the distance. Thus, the coordinate detection unit 22, implemented by the camera and a sound wave receiver, detects position coordinates of the electronic pen 2501. Handwritten data is drawn (projected) at the position of the electronic pen 2501.

The projector 411 projects a menu 430. When the user presses a button of the menu 430 with the electronic pen 2501, the projector 411 determines the pressed button based on the position of the electronic pen 2501 and the ON signal of the switch. For example, when a save button 431 is pressed, handwritten data (coordinate point sequence) input by the user is saved in the projector 411. The projector 411 stores the handwritten information in a predetermined server 412, the USB memory 2600, or the like. Handwritten information is stored for each page. Handwritten information is stored not as image data but as coordinates, and the user can re-edit the handwritten information. However, in the present embodiment, an operation command can be called by handwriting, and the menu 430 does not have to be displayed.

### Embodiment 4

A description is given below of another example of the configuration of the display system.

FIG. 28 is a diagram illustrating another example of the configuration of the display system. In the example illustrated FIG. 28, the display system includes an information processing terminal 600 (e.g., a PC), an image projector 700A, and a pen motion detector 810.

The information processing terminal 600 is coupled to the image projector 700A and the pen motion detector 810 by wire. The image projector 700A projects image data input from the information processing terminal 600 onto the screen 800.

The pen motion detector 810 communicates with an electronic pen 820 to detect a motion of the electronic pen 820 in the vicinity of the screen 800. More specifically, the pen motion detector 810 detects coordinate information indicating a position pointed by the electronic pen 820 on the screen 800 (in a method similar to that described with reference to FIG. 27) and transmits the coordinates to the information processing terminal 600. Thus, the coordinate detection unit 22 and the contact detection unit 24 are implemented by the pen motion detector 810. The display superimposing unit 38 is implemented by the image projector 700A. Other functional units are implemented by the information processing terminal 600.

Based on the coordinate information received from the pen motion detector 810, the information processing terminal 600 generates image data based on handwritten data input by the electronic pen 820 and causes the image projector 700A to project, on the screen 800, an image based on the handwritten data.

The information processing terminal 600 generates data of a superimposed image in which an image based on handwritten data input by the electronic pen 820 is superimposed on the background image projected by the image projector 700A.

### Embodiment 5

A description is given below of another example of the configuration of the display system.

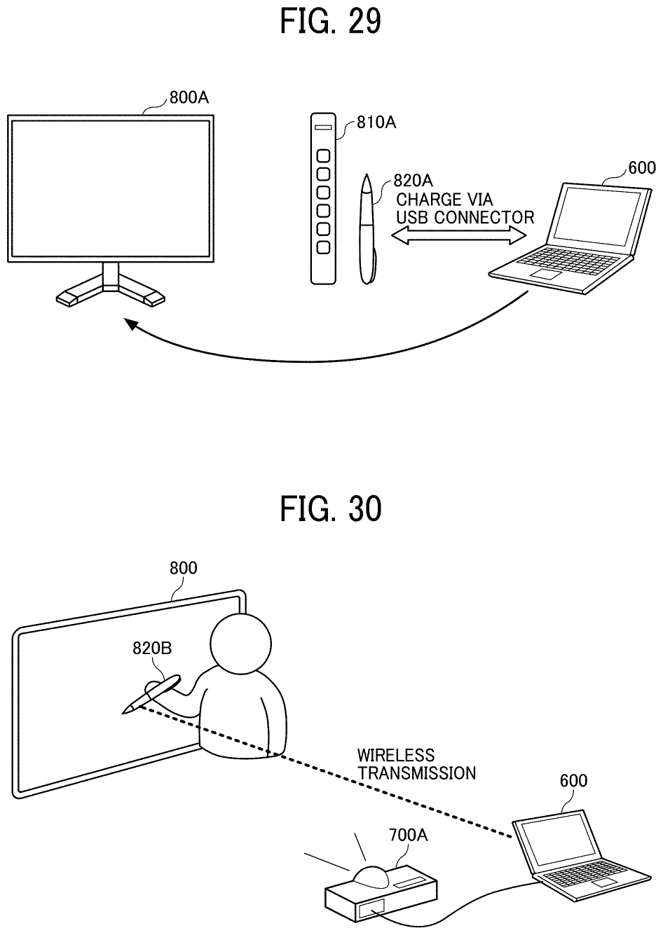

FIG. 29 is a diagram illustrating another example of the configuration of the display system. In the example illustrated FIG. 29, the display system includes the information processing terminal 600, a display 800A, and a pen motion detector 810A.

The pen motion detector 810A is disposed in the vicinity of the display 800A. The pen motion detector 810A detects coordinate information indicating a position pointed by an electronic pen 820A on the display 800A and transmits the coordinate information to the information processing terminal 600. The coordinate information may be detected in a method similar to that of FIG. 27. In the example illustrated FIG. 29, the electronic pen 820A is charged from the information processing terminal 600 via a USB connector.

Based on the coordinate information received from the pen motion detector 810, the information processing terminal 600 generates image data of handwritten data input by the electronic pen 820A and displays an image based on the handwritten data on the display 800A.

### Embodiment 6

A description is given below of another example of the configuration of the display system.

FIG. 30 is a diagram illustrating an example of the configuration of a display system. In the example illustrated FIG. 30, the display system includes the information processing terminal 600 and the image projector 700A.

The information processing terminal 600 communicates with an electronic pen 820B through by wireless communication such as BLUETOOTH, to receive coordinate information indicating a position pointed by the electronic pen 820B on the screen 800. The electronic pen 820B may read minute position information on the screen 800, or receive the coordinate information from the screen 800.

Based on the received coordinate information, the information processing terminal 600 generates image data of handwritten data input by the electronic pen 820B, and causes the image projector 700A to project an image based on the handwritten data.

The information processing terminal 600 generates data of a superimposed image in which an image based on handwritten data input by the electronic pen 820B is superimposed on the background image projected by the image projector 700A.

The embodiments described above are applied to various system configurations.

Now, descriptions are given of other variations of the embodiments described above.

The present disclosure is not limited to the details of the embodiments described above, and various modifications and improvements are possible. For example, a combination of Embodiment 1 with Embodiment 2, a combination of Embodiment 1 with Embodiment 3, a combination of Embodiment 1 with Embodiment 4, a combination of Embodiment 1 with Embodiment 5, a combination of Embodiment 2 with Embodiment 3, a combination of Embodiment 2 with Embodiment 4, and a combination of Embodiment 2 with Embodiment 5 are also possible.

In the above-described embodiments, the display apparatus is usable as an electronic whiteboard. However, the display apparatus may be any display apparatus, such as a digital signage, that displays an image. Instead of the display apparatus, a projector may perform displaying. In this case, the display apparatus 2 may detect the coordinates of the tip of the pen using ultrasonic waves, although the coordinates of the tip of the pen are detected using the touch panel in the above-described embodiment. The pen emits an ultrasonic wave in addition to the light, and the display apparatus 2 calculates a distance based on an arrival time of the sound wave. The display apparatus 2 determines the position of the pen based on the direction and the distance. The projector draws (projects) the trajectory of the pen as a stroke.

In alternative to the electronic whiteboard described above, the present disclosure is applicable to any information processing apparatus with a touch panel. An apparatus having capabilities similar to that of an electronic whiteboard is also called an electronic information board or an interactive board. Examples of the information processing apparatus with a touch panel include, but not limited to, a projector (PJ), a data output device such as a digital signage, a head up display (HUD), an industrial machine, an imaging device such as a digital camera, a sound collecting device, a medical device, a network home appliance, a laptop computer, a mobile phone, a smartphone, a tablet terminal, a game console, a personal digital assistant (PDA), a wearable PC, and a desktop PC.

In the block diagram such as FIG. 4, functional units are divided into blocks in accordance with main functions of the display apparatus 2, in order to facilitate understanding the operation by the display apparatus 2. Each processing unit or each specific name of the processing unit is not to limit a scope of the present disclosure. A process implemented by the display apparatus 2 may be divided into a larger number of processing units depending on the content of the processing. In addition, a single processing unit can be further divided into a plurality of processing units.

Each of the functions of the described embodiments may be implemented by one or more processing circuits or circuitry. Here, the “processing circuit or circuitry” in the present specification includes a programmed processor to execute each function by software, such as a processor implemented by an electronic circuit, and devices, such as an application specific integrated circuit (ASIC), a digital signal processors (DSP), a field programmable gate array (FPGA), and conventional circuit modules designed to perform the recited functions.

The coordinate detection unit 22 and the stroke processing unit 32 are examples of a receiving unit. The table processing unit 33 is an example of a conversion unit. The UI image generation unit 36 is an example of a setting screen display unit. The operation processing unit 26 is an example of an operation receiving unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

One aspect of the present disclosure provides a non-transitory recording medium storing a plurality of program codes which, when executed by one or more processors, causes the processors to perform a method for converting a table on a display. The method includes displaying the table on the screen; acquiring, from a memory, an attribute associated with the table; receiving handwritten data input to the table by a user operation; and converting the handwritten data into a character string in accordance with the attribute associated with the table.

1. A display apparatus comprising circuitry configured to:
display a table on a screen;
acquire, from a memory, an attribute associated with the table;
receive handwritten data input to the table by a user operation; and
convert the handwritten data into a character string so as to have an appearance in accordance with the attribute associated with the table.

2. The display apparatus according to claim 1,
wherein the circuitry:
determines an occurrence of a stroke input event in the table as input of the handwritten data to the table; and
converts the handwritten data into the character string in accordance with the attribute, based on a determination of an elapse of a time from an end of the stroke input event.

3. The display apparatus according to claim 1,
wherein the circuitry:
displays a graphical representation for formatting the table on the screen; and
converts the handwritten data into the character string in accordance with the attribute, in response to selection of the graphical representation.

4. The display apparatus according to claim 3,
wherein, in a case where the table includes the handwritten data and another character string, the circuitry displays the another character string in accordance with the attribute associated with the table, in addition to the character string converted from the handwritten data, in response to the selection of the graphical representation for formatting the table.

5. The display apparatus according to claim 1,
wherein, in converting, the circuitry:
converts the handwritten data into the character string; and
formats the converted character string in accordance with the attribute associated with the table, and
displays the table including the character string having the appearance in accordance with the attribute associated with the table.

6. The display apparatus according to claim 1,
wherein the attribute includes a font.

7. The display apparatus according to claim 1,
wherein the attribute includes a font size.

8. The display apparatus according to claim 1,
wherein the attribute includes a background color.

9. The display apparatus according to claim 1,
wherein the attribute includes an alignment of the character string in a cell of the table.

10. The display apparatus according to claim 1,
wherein the attribute includes a setting indicating whether to automatically adjust a horizontal length of a cell of the table to match a size of the character string in the cell.

11. The display apparatus according to claim 1,
wherein the attribute includes a setting indicating whether a cell of the table is a title cell.

12. The display apparatus according to claim 1,
wherein the circuitry determines an occurrence of a stroke input event in the table as input of the handwritten data to the table; and
wherein the attribute includes a setting indicating whether to automatically convert the handwritten data into the character string in response to an elapse of a time from an end of the stroke input event.

13. The display apparatus according to claim 1,
wherein the circuitry:
displays a setting screen to receive a set value of the attribute; and
receives the set value input on the setting screen.

14. A display system comprising:
the display apparatus of claim 1;
a server configured to receive from the display apparatus the converted character string and data of the table; and
a communication terminal configured to communicate with the server via a network, the communication terminal being configured to display the table and the converted character string received from the server.

15. A display system comprising:
a display apparatus including first circuitry configured to display a table on a screen; and
a server including second circuitry configured to:
receive from the display apparatus data of the table and handwritten data input to the table by a user operation;
acquire, from a memory, an attribute associated with the table;
convert the handwritten data into a character string so as to have appearance in accordance with the attribute associated with the table; and
transmit, to the display apparatus, the converted character string and data of the table,
the first circuitry of the display apparatus being further configured to display the table and the converted character string.

16. A method for converting a table on a display, the method comprising:
displaying the table on the display;
acquiring, from a memory, an attribute associated with the table;
receiving handwritten data input to the table by a user operation; and
converting the handwritten data into a character string so as to have an appearance in accordance with the attribute associated with the table.
